(19) United States
(12) Patent Application Publication
(10) Pub. No.: US 2025/0351019 A1
(43) Pub. Date: Nov. 13, 2025

(54) HANDLING OF MULTIPLE TARGET SECONDARY NODES IN AN SN-INITIATED CONDITIONAL SECONDARY NODE CHANGE

(71) Applicant: GOOGLE LLC, Mountain View, CA (US)

(72) Inventors: Jing-Rong Hsieh, Taoyuan City (TW); Chih-Hsiang Wu, Taoyuan City (TW)

(21) Appl. No.: 18/860,911

(22) PCT Filed: Apr. 26, 2023
(86) PCT No.: PCT/US23/20088

§ 371 Date: Oct. 28, 2024

Related U.S. Application Data
(60) Provisional application No. 63/335,216, filed on Apr. 26, 2022.

(51) Int. Cl. H04W 36/00; H04W 36/24

(52) U.S. Cl. CPC H04W 36/0064; H04W 36/0069; H04W 36/24

(57) ABSTRACT

A master mode (MN) provides, with a source secondary node (S-SN), a dual connectivity (DC) connection to a user equipment (UE). A method in the MN includes receiving, from the S-SN, a first message indicating that a change in the SN is required for the UE, the message including a plurality of information elements (IBs) for a plurality of target SNs, to one of which the UE connects after a respective condition is satisfied, each of the IBs including an identifier of a respective one of the plurality of target SNs; and transmitting, to the S-SN, a second message indicating that the change in the SN is confirmed.

### CROSS-REFERENCE TO RELATED APPLICATION

This application claims priority to and the benefit of the filing date of provisional U.S. Patent Application No. 63/335,216, titled “HANDLING OF MULTIPLE TARGET SECONDARY NODES IN AN SN-INITIATED CONDITIONAL SECONDARY NODE CHANGE,” filed on Apr. 26, 2022. The entire contents of the provisional application are hereby expressly incorporated herein by reference.

### FIELD OF THE DISCLOSURE

This disclosure relates generally to wireless communications and, more particularly, to managing conditional configurations for multi-connectivity such as conditional secondary node addition or change procedures.

### BACKGROUND

This background description is provided for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In telecommunication systems, a user equipment (UE) sometimes can concurrently utilize resources of multiple radio access network (RAN) nodes, such as base stations or components of a distributed base station, interconnected by a backhaul. When these network nodes support different radio access technologies (RATs), this type of connectivity is referred to as Multi-Radio Dual Connectivity (MR-DC). When a UE operates in MR-DC, one base station operates as a master node (MN) that covers a primary cell (PCell), and the other base station operates as a secondary node (SN) that covers a primary secondary cell (PSCell). The UE communicates with the MN (via the PCell) and the SN (via the PSCell). In other scenarios, the UE transfers a wireless connection from one base station to another base station. For example, a serving base station can determine to hand the UE over to a target base station and initiate a handover procedure.

3GPP specification TS 37.340 v16.6.0 describes procedures for a UE to add or change an SN in DC scenarios. These procedures involve messaging (e.g., RRC signaling and preparation) between radio access network (RAN) nodes. This messaging generally causes latency, which in turn increases the probability that the SN addition or SN change procedure will fail. These legacy procedures, which do not involve conditions that are checked at the UE, can be referred to as “immediate” SN addition and SN change procedures.

More recently, for both SN or PSCell addition/change, “conditional” procedures have been considered (i.e., conditional SN or PSCell addition/change). Unlike the “immediate” procedures discussed above, these procedures do not add or change the SN or PSCell, or perform the handover, until the UE determines that a condition is satisfied. As used herein, the term “condition” may refer to a single, detectable state or event (e.g., a particular signal quality metric exceeding a threshold), or to a logical combination of such states or events (e.g., “Condition A and Condition B,” or “(Condition A or Condition B) and Condition C”, etc.).

To configure a conditional procedure, the RAN provides the condition to the UE, along with a configuration (e.g., one or more random-access preambles, etc.) that will enable the UE to communicate with the appropriate base station, or via the appropriate cell, when the condition is satisfied. For a conditional addition of a base station as an SN or a candidate cell as a PSCell, for example, the RAN provides the UE with a condition to be satisfied before the UE can add that base station as the SN or that candidate cell as the PSCell, and a configuration that enables the UE to communicate with that base station or PSCell after the condition has been satisfied.

In the immediate PSCell addition or change procedure, the RAN (i.e., MN or SN) transmits an RRC reconfiguration message including multiple configuration parameters to the UE and the UE attempts to connect to a (target) PSCell configured by the RRC reconfiguration message. After the UE successfully connects to the SN via the PSCell, the UE communicates with the SN on the PSCell by using the multiple configuration parameters and security key(s) associated to the PSCell and derived from one or more security configuration parameters in the RRC reconfiguration message. The SN also derives security key(s) that match the security key(s) derived from the UE. After the UE successfully connects to the PSCell, the RAN (e.g., the SN) communicates data with the UE by using the matching security key(s) and the multiple configuration parameters.

In some cases, a candidate SN (C-SN), also referred to below as a target SN (T-SN), identifies multiple candidate PSCells and generates multiple candidate configurations. When the MN completes the preparation for a conditional SN procedure (e.g., conditional SN addition or conditional SN cell change), the MN cannot determine to which candidate secondary cell the UE will connect in the future. Moreover, because the UE connects to the secondary cell only subject to the fulfillment of one or more conditions, the MN cannot determine whether the UE will connect to any of the candidate cells at all.

### SUMMARY

An example implementation of the techniques of this disclosure is a method in a master mode (MN) that provides, with a source secondary node (S-SN), a dual connectivity (DC) connection to a user equipment (UE). The method comprises receiving, from the S-SN, a first message indicating that a change in the SN is required for the UE, the message including a plurality of information elements (IEs) for a plurality of target SNs, to one of which the UE connects after a respective condition is satisfied, each of the IEs including an identifier of a respective one of the plurality of target SNs; and transmitting, to the S-SN, a second message indicating that the change in the SN is confirmed.

Another example implementation of these techniques is method in a source secondary node (S-SN) that provides, with a master node (MN), a dual connectivity (DC) connection to a user equipment (UE). The method includes transmitting, to the MN, a first message indicating that a change in the SN is required for the UE, the message including a plurality of information elements (TEs) for a plurality of target SNs, to one of which the UE connects after a respective condition is satisfied, each of the IEs including an identifier of a respective one of the plurality of target SNs; and receiving, from the MN, a second message indicating that the change in the SN is confirmed.

Yet another example implementation of these techniques is node in a radio access network (RAN) comprising processing hardware and configured to implement one of the methods above.

### BRIEF DESCRIPTION OF THE DRAWINGS

FIG. 1A is a block diagram of an example system in which a base station and/or a user equipment (UE) can implement the techniques of this disclosure for managing conditional procedures related to a master node (MN) or a secondary node (SN);

FIG. 1B is a block diagram of another example system in which a radio access network (RAN) and a user device can implement the techniques of this disclosure for managing conditional procedures related to an MN or an SN;

FIG. 1C is a block diagram of an example base station including a central unit (CU) and a distributed unit (DU) that can operate in the system of FIG. 1A or FIG. 1B;

FIG. 2 is a block diagram of an example protocol stack according to which the UE of FIGS. 1A-lB can communicate with base stations;

FIG. 3A is a messaging diagram of an example scenario where an MN receives and processes one or more SN configurations from a C-SN during a Conditional SN Addition procedure;

FIG. 3B is a messaging diagram of an example scenario where an MN receives and processes one or more SN configurations from a C-SN during an MN-initiated Conditional SN Change procedure;

FIG. 3C is a messaging diagram of an example scenario where an MN receives and processes one or more SN configurations from a C-SN during an SN-initiated Conditional SN Change procedure;

FIG. 3D is a messaging diagram of an example scenario where the MN initiates a modification to the prepared conditional configuration(s) after the MN-initiated Conditional SN Addition or Change or the SN-initiated Conditional SN Change procedure;

FIG. 3E is a messaging diagram of an example scenario where an S-SN initiates a modification to the prepared conditional configuration(s) after the MN-initiated Conditional SN Change or the SN-initiated Conditional SN Change procedure;

FIG. 3F is a messaging diagram of an example scenario where the C-SN initiates a modification to the prepared conditional configuration(s) after MN-initiated Conditional SN Addition or Change or the SN-initiated Conditional SN Change procedure;

FIG. 4A is a flow diagram of an example method for initiating a conditional SN Change procedure related to one or more C-SNs using one or more CG-Config IE(s), which can be implemented in a C-SN;

FIG. 4B is a flow diagram of an example a method for initiating a conditional SN Change procedure related to one or more C-SNs using a container IE enclosing one or more CG-Config IE(s), which can be implemented in a C-SN;

FIG. 4C is a flow diagram of an example a method for initiating a conditional SN Change procedure related to one or more C-SNs using a container IE enclosing a single CG-Config IE, which can be implemented in a C-SN;

FIG. 5A is a flow diagram of an example method for performing a conditional SN Change procedure initiated by an S-SN and related to one or more C-SNs, using one or more CG-Config IE(s), which can be implemented in an MN;

FIG. 5B is a flow diagram of an example method for performing a conditional SN Change procedure initiated by an S-SN and related to one or more C-SNs, using a container IE enclosing one or more CG-Config IE(s), which can be implemented in an MN;

FIG. 5C is a flow diagram of an example method for performing a conditional SN Change procedure initiated by an S-SN and related to one or more C-SNs, using a container IE enclosing a single CG-Config IE, which can be implemented in an MN;

FIG. 5D is a flow diagram of an example method for performing a conditional SN Change procedure initiated by an S-SN and related to one or more C-SNs, using a container IE enclosing a single CG-Config IE, which can be implemented in an MN;

FIG. 6A is a flow diagram of an example method for performing a conditional SN Change procedure, initiated by an S-SN and related to one or more C-SNs, and maintaining the execution condition(s) for C-SN configuration modification, which can be implemented in an MN;

FIG. 6B is a flow diagram of an example method for performing a conditional SN Change procedure initiated by an S-SN and related to one or more C-SNs for a UE, re-acquiring the execution condition(s) for C-SN configuration modification;

FIG. 7 is a flow diagram of an example method for performing a conditional SN procedure for a UE with an SN, which can be implemented in an MN; and

FIG. 8 is a flow diagram of an example method for performing a conditional SN procedure for a UE with an MN, which can be implemented in an SN;

### DETAILED DESCRIPTION OF THE DRAWINGS

As discussed in detail below, a UE and/or one or more base stations manage conditional procedures, such as conditional PSCell addition or change (CPAC) (the description also refers to the conditional PSCell addition procedure and the conditional PSCell change procedure separately using the acronyms CPA and CPC, respectively). More particularly, the base stations use a single SN Change procedure during the preparation phase for an SN-initiated CPC, to prepare multiple C-SNs and exchange information related to S-SN configurations between the S-SN and the MN. For example, the S-SN can transmit to the MN a list of proposed candidate PSCells of the C-SNs, where the list includes, for each proposed candidate PSCell, an execution condition. The MN and/or the S-SN use certain formats discussed below to manage the list of candidate PSCells and the corresponding C-SNs in a single SN Change procedure, so as to reduce the complexity of determining, at the MN, which candidate PSCells belong to a specific C-SN, and performing the follow-up conditional SN addition preparation with the C-SN.

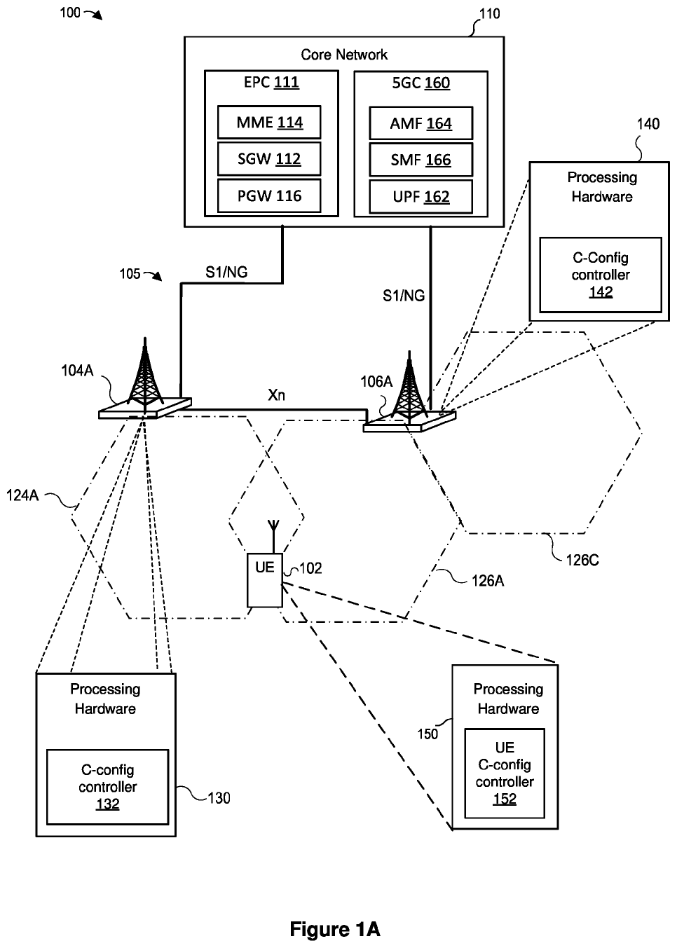

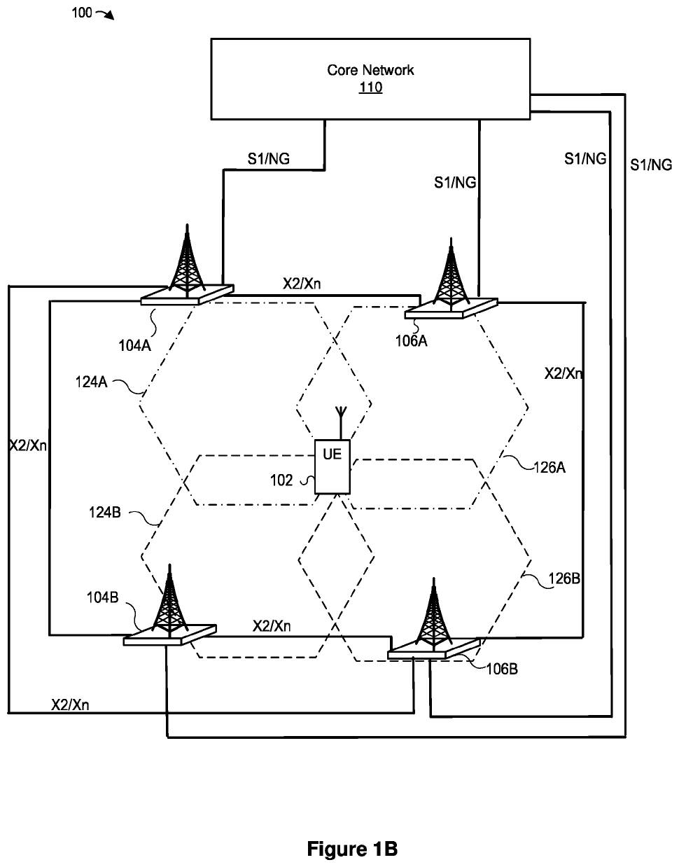

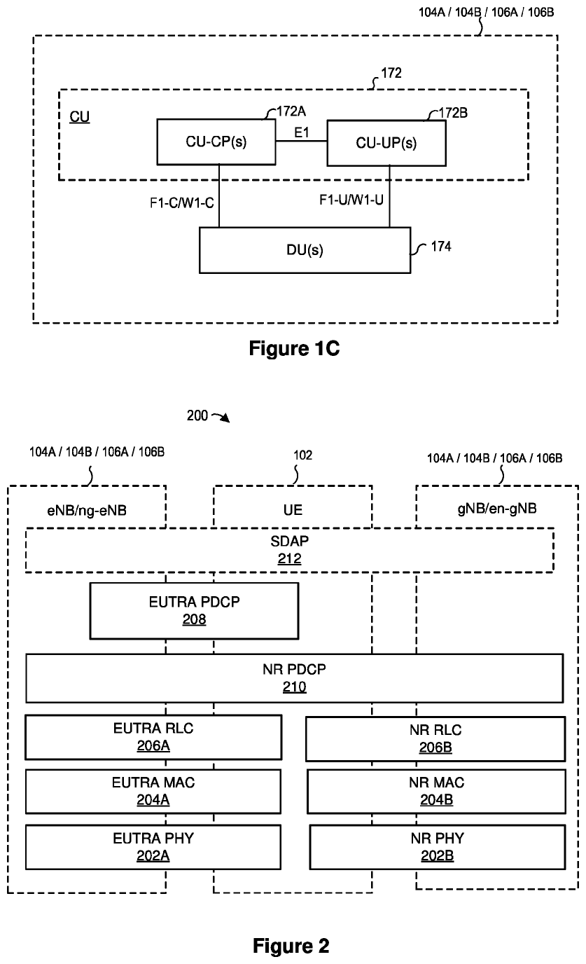

Referring first to FIG. 1A, an example wireless communication system 100 includes a UE 102, a base station (BS) 104A, a base station 106A, and a core network (CN) 110. The base stations 104A and 106A can operate in a RAN 105 connected to the same core network (CN) 110. The CN 110 can be implemented as an evolved packet core (EPC) 111 or a fifth generation (5G) core (5GC) 160, for example.

Among other components, the EPC 111 can include a Serving Gateway (SGW) 112, a Mobility Management Entity (MME) 114, and a Packet Data Network Gateway (PGW) 116. The SGW 112 in general is configured to transfer user-plane packets related to audio calls, video calls, Internet traffic, etc., and the MME 114 is configured to manage authentication, registration, paging, and other related functions. The PGW 116 provides connectivity from the UE to one or more external packet data networks, e.g., an Internet network and/or an Internet Protocol (IP) Multimedia Subsystem (IMS) network. The 5GC 160 includes a User Plane Function (UPF) 162 and an Access and Mobility Management Function (AMF) 164, and/or Session Management Function (SMF) 166. Generally speaking, the UPF 162 is configured to transfer user-plane packets related to audio calls, video calls, Internet traffic, etc.; the AMF 164 is configured to manage authentication, registration, paging, and other related functions; and the SMF 166 is configured to manage PDU sessions.

As illustrated in FIG. 1A, the base station 104A supports a cell 124A, and the base station 106A supports a cell 126A. Further, each of the base stations 104A, 106A may support more than one cell. The base station 106A, for example, may also support a cell 126C. The cells 124A and 126A can partially overlap, so that the UE 102 can communicate in DC with the base station 104A and the base station 106A operating as a master node (MN) and a secondary node (SN), respectively. To directly exchange messages during DC scenarios and other scenarios discussed below, the MN 104A and the SN 106A can support an X2 or Xn interface. In general, the CN 110 can connect to any suitable number of base stations supporting NR cells and/or EUTRA cells. An example configuration in which the EPC 110 is connected to additional base stations is discussed below with reference to FIG. 1B.

The base station 104A is equipped with processing hardware 130 that can include one or more general-purpose processors such as CPUs and non-transitory computer-readable memory storing machine-readable instructions executable on the one or more general-purpose processors, and/or special-purpose processing units. The processing hardware 130 in an example implementation includes a conditional configuration controller 132 configured to manage conditional configuration for one or more conditional procedures such as Conditional Handover (CHO), Conditional PSCell Addition or Change (CPAC), or Conditional SN Additional or Change (CSAC), when the base station 104A operates as an MN.

The base station 106A is equipped with processing hardware 140 that can also include one or more general-purpose processors such as CPUs and non-transitory computer-readable memory storing machine-readable instructions executable on the one or more general-purpose processors, and/or special-purpose processing units. The processing hardware 140 in an example implementation includes a conditional configuration controller 142 configured to manage conditional configurations for one or more conditional procedures such as CHO, CPAC, or CSAC, when the base station 106A operates as an SN.

Still referring to FIG. 1A, the UE 102 is equipped with processing hardware 150 that can include one or more general-purpose processors such as CPUs and non-transitory computer-readable memory storing machine-readable instructions executable on the one or more general-purpose processors, and/or special-purpose processing units. The processing hardware 150 in an example implementation includes a UE conditional configuration controller 152 configured to manage conditional configuration for one or conditional procedures.

More particularly, the conditional configuration controllers 132, 142, and 152 can implement at least some of the techniques discussed with reference to the messaging and flow diagrams below. Although FIG. 1A illustrates the conditional configuration controllers 132 and 142 as separate components, in at least some of the scenarios the base stations 104A and 106A can have similar implementations and in different scenarios operate as MN or SN nodes. In these implementations, each of the base stations 104A and 106A can implement both the conditional configuration controller 132 and the conditional configuration controller 142 to support MN and SN functionality, respectively.

In operation, the UE 102 can use a radio bearer (e.g., a DRB or an SRB) that at different times terminates at the MN 104A or the SN 106A. The UE 102 can apply one or more security keys when communicating on the radio bearer, in the uplink (from the UE 102 to a BS) and/or downlink (from a base station to the UE 102) direction. The UE in some cases can use different RATs to communicate with the base stations 104A and 106A. Although the examples below may refer specifically to specific RAT types, 5G NR or EUTRA, in general the techniques of this disclosure also can apply to other suitable radio access and/or core network technologies.

FIG. 1B depicts additional base stations 104B and 106B, which may be included in the wireless communication system 100. The UE 102 initially connects to the base station 104A. The BSs 104B and 106B may have similar processing hardware as the base station 106A. The UE 102 initially connects to the base station 104A.

In some scenarios, the base station 104A can perform immediate SN addition to configure the UE 102 to operate in dual connectivity (DC) with the base station 104A (via a PCell) and the base station 106A (via a PSCell other than cell 126A). The base stations 104A and 106A operate as an MN and an SN for the UE 102, respectively. The UE 102 in some cases can operate using the MR-DC connectivity mode, e.g., communicate with the base station 104A using 5G NR and communicate with the base station 106A using EUTRA, or communicate with the base station 104A using EUTRA and communicate with the base station 106A using 5G NR. Multi-connectivity coordination can help the two base stations coordinate shared UE capabilities including operational frequencies (e.g., band combinations, frequency ranges), UE measurements and reporting (e.g., intra-frequency measurements, inter-frequency measurements, inter-RAT measurements, measurement gaps), reception timing (e.g., DRX configurations, offset timing), and uplink power control (e.g., power headroom, maximum transmit power).

At some point, the MN 104A can perform an immediate SN change to change the SN of the UE 102 from the base station 106A (source SN, or “S-SN”) to the base station 104B (target SN, or “T-SN”) while the UE 102 is communicating in DC with the MN 104A and the S-SN 106A. In another scenario, the SN 106A can perform an immediate PSCell change to change the PSCell of the UE 102 to the cell 126A. In one implementation, the SN 106A can transmit a configuration changing the PSCell to cell 126A to the UE 102 via a signaling radio bearer (SRB) (e.g., SRB3) for the immediate PSCell change. In another implementation, the SN 106A can transmit a configuration changing the PSCell to the cell 126A to the UE 102 via the MN 104A for the immediate PSCell change. The MN 104A may transmit the configuration immediately changing the PSCell to the cell 126A to the UE 102 via SRB1. Extending multi-connectivity coordination can help the newly-added base station coordinate shared UE capabilities.

In other scenarios, the base station 104A can perform a conditional SN Addition procedure to first configure the base station 106B as a C-SN for the UE 102, i.e., conditional SN addition or change (CSAC). At this time, the UE 102 can be in single connectivity (SC) with the base station 104A or in DC with the base station 104A and the base station 106A. If the UE 102 is in DC with the base station 104A and the base station 106A, the MN 104A may determine to perform the conditional SN Addition procedure in response to a request received from the base station 106A or in response to one or more measurement results received from the UE 102 (e.g., extracted from a UE measurement report) or obtained by the MN 104A from measurements on signals (e.g., sounding reference signal (SRS) or uplink demodulation reference signal (DMRS)) received from the UE 102. In contrast to the immediate SN Addition case discussed above, the UE 102 does not immediately attempt to connect to the C-SN 106B. In this scenario, the base station 104A again operates as an MN, but the base station 106B initially operates as a C-SN rather than an SN.

More particularly, when the UE 102 receives a configuration for the C-SN 106B, the UE 102 does not connect to the C-SN 106B until the UE 102 has determined that a certain condition is satisfied (the UE 102 in some cases can consider multiple conditions, but for convenience only the discussion below refers to a single condition). Before the condition is satisfied, multi-connectivity coordination is not necessary; however, it will be helpful as soon as a C-SN becomes connected. When the UE 102 determines that the condition has been satisfied, the UE 102 connects to the C-SN 106B, so that the C-SN 106B begins to operate as the SN 106B for the UE 102. Thus, while the base station 106B operates as a C-SN rather than an SN, the base station 106B is not yet connected to the UE 102, and accordingly is not yet servicing the UE 102. In some implementations, the UE 102 may disconnect from the SN 106A to connect to the C-SN 106B.

In yet other scenarios, the UE 102 is in DC with the MN 104A (via a PCell) and SN 106A (via a PSCell other than cell 126A and not shown in FIG. 1A). The SN 106A can perform conditional PSCell addition or change (CPAC) to configure a candidate PSCell (C-PSCell) 126A for the UE 102. If the UE 102 is configured with a signaling radio bearer (SRB) (e.g., SRB3) to exchange RRC messages with the SN 106A, the SN 106A may transmit a configuration for the C-PSCell 126A to the UE 102 via the SRB, e.g., in response to one or more measurement results, which may be received from the UE 102 via the SRB or via the MN 104A or may be obtained by the SN 106A from measurements on signals received from the UE 102. In case of via the MN 104A, the MN 104A receives the configuration for the C-PSCell 126A. In contrast to the immediate PSCell change case discussed above, the UE 102 does not immediately disconnect from the PSCell and attempt to connect to the C-PSCell 126A.

More particularly, when the UE 102 receives a configuration for the C-PSCell 126A, the UE 102 does not connect to the C-PSCell 126A until the UE 102 has determined that a certain condition is satisfied (the UE 102 in some cases can consider multiple conditions, but for convenience only the discussion below refers to a single condition). When the UE 102 determines that the condition has been satisfied, the UE 102 connects to the C-PSCell 126A, so that the C-PSCell 126A begins to operate as the PSCell 126A for the UE 102. Thus, while the cell 126A operates as a C-PSCell rather than a PSCell, the SN 106A may not yet connect to the UE 102 via the cell 126A. In some implementations, the UE 102 may disconnect from the PSCell to connect to the C-PSCell 126A.

In some scenarios, the condition associated with CSAC or CPAC can be signal strength/quality, which the UE 102 detects on the C-PSCell 126A of the SN 106A or on a C-PSCell 126B of C-SN 106B, exceeding a certain threshold or otherwise corresponding to an acceptable measurement. For example, when the one or more measurement results the UE 102 obtains on the C-PSCell 126A are above a threshold configured by the MN 104A or the SN 106A or above a pre-determined or pre-configured threshold, the UE 102 determines that the condition is satisfied. When the UE 102 determines that the signal strength/quality on the C-PSCell 126A of the SN 106A is sufficiently good (again, measured relative to one or more quantitative thresholds or other quantitative metrics), the UE 102 can perform a random access procedure on the C-PSCell 126A with the SN 106A to connect to the SN 106A. After the UE 102 successfully completes the random access procedure on the C-PSCell 126A, the C-PSCell 126A becomes a PSCell 126A for the UE 102. The SN 106A then can start communicating data (user-plane data or control-plane data) with the UE 102 through the PSCell 126A. In another example, when the one or more measurement results the UE 102 obtains on the C-PSCell 126B are above a threshold configured by the MN 104A or the C-SN 106B or above a pre-determined or pre-configured threshold, the UE 102 determines that the condition is satisfied. When the UE 102 determines that the signal strength/quality on the C-PSCell 126B of the C-SN 106B is sufficiently good (again, measured relative to one or more quantitative thresholds or other quantitative metrics), the UE 102 can perform a random access procedure on the C-PSCell 126B with the C-SN 106B to connect to the C-SN 106B. After the UE 102 successfully completes the random access procedure on the C-PSCell 126B, the C-PSCell 126B becomes a PSCell 126B for the UE 102 and the C-SN 106B becomes an SN 106B. The SN 106B then can start communicating data (user-plane data or control-plane data) with the UE 102 through the PSCell 126B.

In various configurations of the wireless communication system 100, the base station 104A can be implemented as a master eNB (MeNB) or a master gNB (MgNB), and the base station 106A or 106B can be implemented as a secondary gNB (SgNB) or a candidate SgNB (C-SgNB). The UE 102 can communicate with the base station 104A and the base station 106A or 106B (106A/B) via the same RAT such as EUTRA or NR, or different RATs. When the base station 104A is an MeNB and the base station 106A is an SgNB, the UE 102 can be in EUTRA-NR DC (EN-DC) with the MeNB and the SgNB. In this scenario, the MeNB 104A might or might not configure the base station 106B as a C-SgNB to the UE 102. In this scenario, the SgNB 106A may configure cell 126A as a C-PSCell to the UE 102. When the base station 104A is an MeNB and the base station 106A is a C-SgNB for the UE 102, the UE 102 can be in SC with the MeNB. In this scenario, the MeNB 104A might or might not configure the base station 106B as another C-SgNB to the UE 102.

In some cases, an MeNB, an SeNB or a C-SgNB is implemented as an ng-eNB rather than an eNB. When the base station 104A is a Master ng-eNB (Mng-eNB) and the base station 106A is a SgNB, the UE 102 can be in next generation (NG) EUTRA-NR DC (NGEN-DC) with the Mng-eNB and the SgNB. In this scenario, the MeNB 104A might or might not configure the base station 106B as a C-SgNB to the UE 102. In this scenario, the SgNB 106A may configure cell 126A as a C-PSCell to the UE 102. When the base station 104A is an Mng-NB and the base station 106A is a C-SgNB for the UE 102, the UE 102 can be in SC with the Mng-NB. In this scenario, the Mng-eNB 104A might or might not configure the base station 106B as another C-SgNB to the UE 102.

When the base station 104A is an MgNB and the base station 106A/B is an SgNB, the UE 102 may be in NR-NR DC (NR-DC) with the MgNB and the SgNB. In this scenario, the MeNB 104A might or might not configure the base station 106B as a C-SgNB to the UE 102. In this scenario, the SgNB 106A may configure cell 126A as a C-PSCell to the UE 102. When the base station 104A is an MgNB and the base station 106A is a C-SgNB for the UE 102, the UE 102 may be in SC with the MgNB. In this scenario, the MgNB 104A might or might not configure the base station 106B as another C-SgNB to the UE 102.

When the base station 104A is an MgNB and the base station 106A/B is a Secondary ng-eNB (Sng-eNB), the UE 102 may be in NR-EUTRA DC (NE-DC) with the MgNB and the Sng-eNB. In this scenario, the MgNB 104A might or might not configure the base station 106B as a C-Sng-eNB to the UE 102. In this scenario, the Sng-eNB 106A may configure cell 126A as a C-PSCell to the UE 102. When the base station 104A is an MgNB and the base station 106A is a candidate Sng-eNB (C-Sng-eNB) for the UE 102, the UE 102 may be in SC with the MgNB. In this scenario, the MgNB 104A might or might not configure the base station 106B as another C-Sng-eNB to the UE 102.

The base stations 104A, 106A, and 106B can connect to the same core network (CN) 110, which can be an evolved packet core (EPC) 111 or a fifth-generation core (5GC) 160. The base station 104A can be implemented as an eNB supporting an S1 interface for communicating with the EPC 111, an ng-eNB supporting an NG interface for communicating with the 5GC 160, or as a base station that supports the NR radio interface as well as an NG interface for communicating with the 5GC 160. The base station 106A can be implemented as an EN-DC gNB (en-gNB) with an S1 interface to the EPC 111, an en-gNB that does not connect to the EPC 111, a gNB that supports the NR radio interface as well as an NG interface to the 5GC 160, or a ng-eNB that supports an EUTRA radio interface as well as an NG interface to the 5GC 160. To directly exchange messages during the scenarios discussed below, the base stations 104A, 106A, and 106B can support an X2 or Xn interface.

As illustrated in FIG. 1B, the base station 104A supports a cell 124A, the base station 104B supports a cell 124B, the base station 106A supports a cell 126A, and the base station 106B supports a cell 126B. The cells 124A and 126A can partially overlap, as can the cells 124A and 124B, so that the UE 102 can communicate in DC with the base station 104A (operating as an MN) and the base station 106A (operating as an SN) and, upon completing an SN change, with the base station 104A (operating as MN) and the SN 104B. More particularly, when the UE 102 operates in DC with the base station 104A and the base station 106A, the base station 104A operates as an MeNB, an Mng-eNB, or an MgNB, and the base station 106A operates as an SgNB or an Sng-eNB. The cells 124A and 126B can partially overlap. When the UE 102 is in SC with the base station 104A, the base station 104A operates as an MeNB, an Mng-eNB or an MgNB, and the base station 106B operates as a C-SgNB or a C-Sng-eNB. When the UE 102 operates in DC with the base station 104A and the base station 106A, the base station 104A operates as an MeNB, an Mng-eNB or an MgNB, the base station 106A operates as an SgNB or an Sng-eNB, and the base station 106B operates as a C-SgNB or a C-Sng-eNB.

In general, the wireless communication network 100 can include any suitable number of base stations supporting NR cells and/or EUTRA cells. More particularly, the EPC 111 or the 5GC 160 can be connected to any suitable number of base stations supporting NR cells and/or EUTRA cells. Although the examples below refer specifically to specific CN types (EPC, 5GC) and RAT types (5G NR and EUTRA), in general the techniques of this disclosure also can apply to other suitable radio access and/or core network technologies such as sixth generation (6G) radio access and/or 6G core network or 5G NR-6G DC.

FIG. 1C depicts an example distributed implementation of a base station such as the base station 104A, 104B, 106A, or 106B. The base station in this implementation can include a central unit (CU) 172 and one or more distributed units (DUs) 174. The CU 172 is equipped with processing hardware that can include one or more general-purpose processors such as CPUs and non-transitory computer-readable memory storing machine-readable instructions executable on the one or more general-purpose processors, and/or special-purpose processing units. In one example, the CU 172 is equipped with the processing hardware 130. In another example, the CU 172 is equipped with the processing hardware 140. The processing hardware 140 in an example implementation includes an (C-)SN RRC controller configured to manage or control one or more RRC configurations and/or RRC procedures when the base station 106A operates as an SN or a candidate SN (C-SN). The base station 106B can have hardware same as or similar to the base station 106A. The DU 174 is also equipped with processing hardware that can include one or more general-purpose processors such as CPUs and non-transitory computer-readable memory storing machine-readable instructions executable on the one or more general-purpose processors, and/or special-purpose processing units. In some examples, the processing hardware in an example implementation includes a medium access control (MAC) controller configured to manage or control one or more MAC operations or procedures (e.g., a random access procedure) and a radio link control (RLC) controller configured to manage or control one or more RLC operations or procedures when the base station 106A operates as an MN, an SN or a candidate SN (C-SN). The processing hardware may include further a physical layer controller configured to manage or control one or more physical layer operations or procedures.

FIG. 2 illustrates, in a simplified manner, an example protocol stack 200 according to which the UE 102 can communicate with an eNB/ng-eNB or a gNB (e.g., one or more of the base stations 104, 106).

In the example stack 200, a physical layer (PHY) 202A of EUTRA provides transport channels to the EUTRA MAC sublayer 204A, which in turn provides logical channels to the EUTRA RLC sublayer 206A. The EUTRA RLC sublayer 206A in turn provides RLC channels to a EUTRA PDCP sublayer 208 and, in some cases, to an NR PDCP sublayer 210. Similarly, the NR PHY 202B provides transport channels to the NR MAC sublayer 204B, which in turn provides logical channels to the NR RLC sublayer 206B. The NR RLC sublayer 206B in turn provides data transfer services to the NR PDCP sublayer 210. The NR PDCP sublayer 210 in turn can provide data transfer services to Service Data Adaptation Protocol (SDAP) 212 or a radio resource control (RRC) sublayer (not shown in FIG. 2). The UE 102, in some implementations, supports both the EUTRA and the NR stack, as shown in FIG. 2, to support handover between EUTRA and NR base stations and/or to support DC over EUTRA and NR interfaces. Further, as illustrated in FIG. 2, the UE 102 can support layering of NR PDCP 210 over EUTRA RLC 206A, and SDAP sublayer 212 over the NR PDCP sublayer 210.

The EUTRA PDCP sublayer 208 and the NR PDCP sublayer 210 receive packets (e.g., from an Internet Protocol (IP) layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets.”

On a control plane, the EUTRA PDCP sublayer 208 and the NR PDCP sublayer 210 can provide signaling radio bearers (SRBs) or an RRC sublayer (not shown in FIG. 2) to exchange RRC messages or non-access-stratum (NAS) messages, for example. On a user plane, the EUTRA PDCP sublayer 208 and the NR PDCP sublayer 210 can provide data radio bearers (DRBs) to support data exchange. Data exchanged on the NR PDCP sublayer 210 can be SDAP PDUs, Internet Protocol (IP) packets, or Ethernet packets.

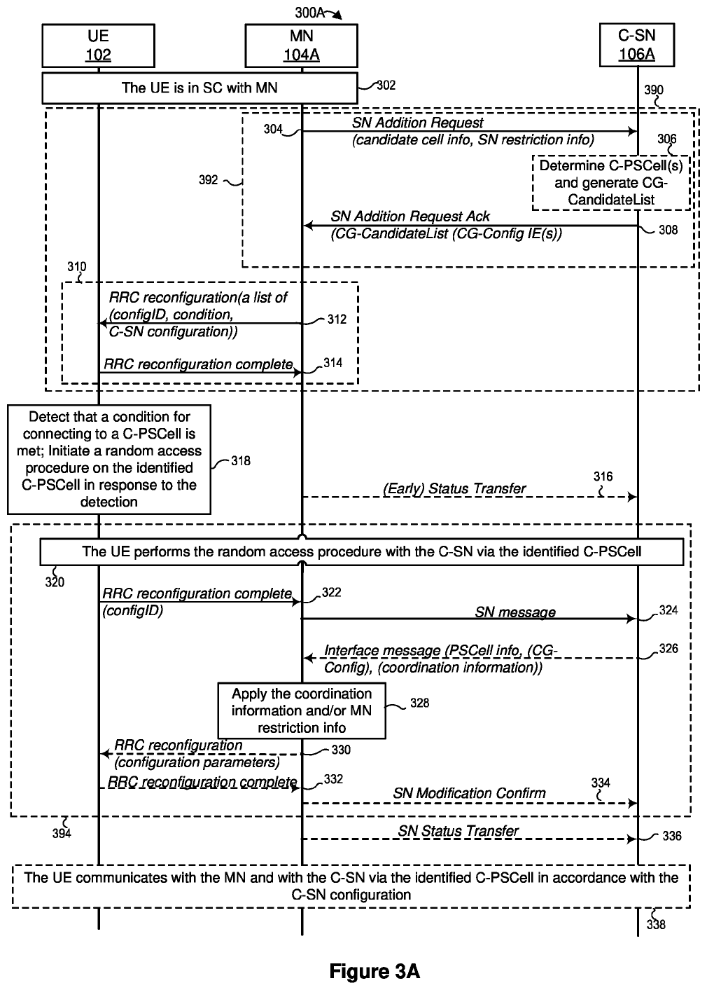

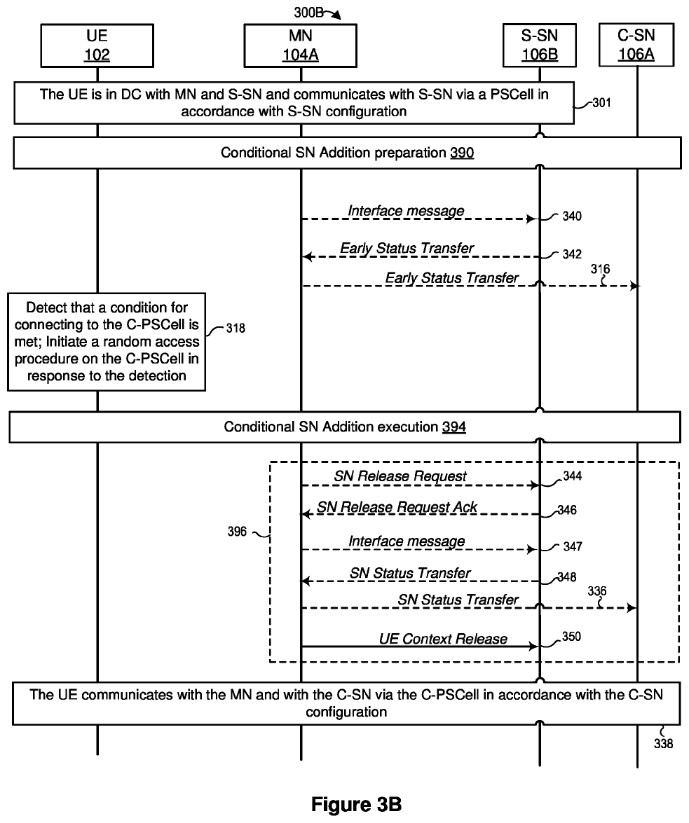

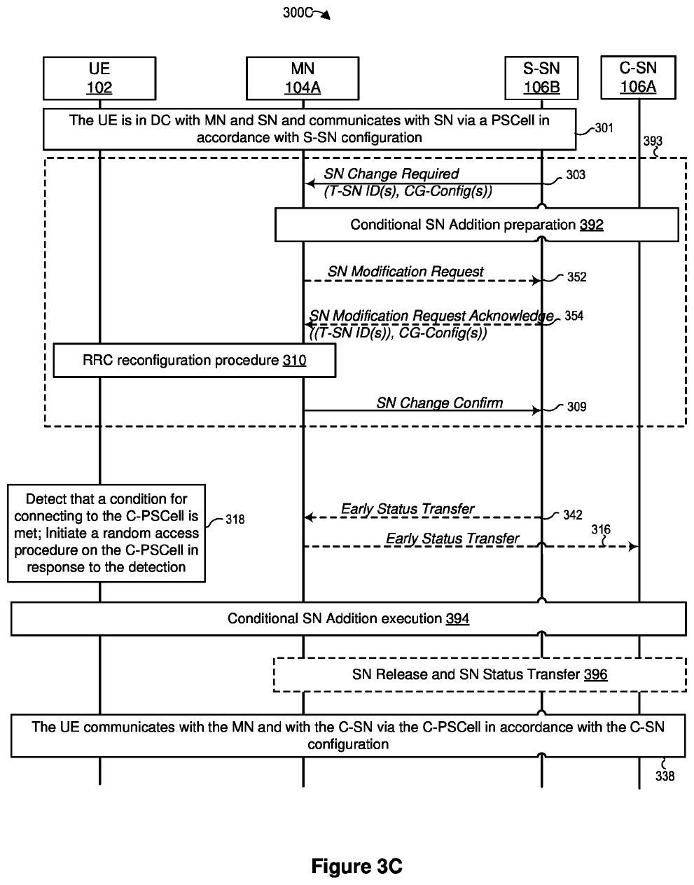

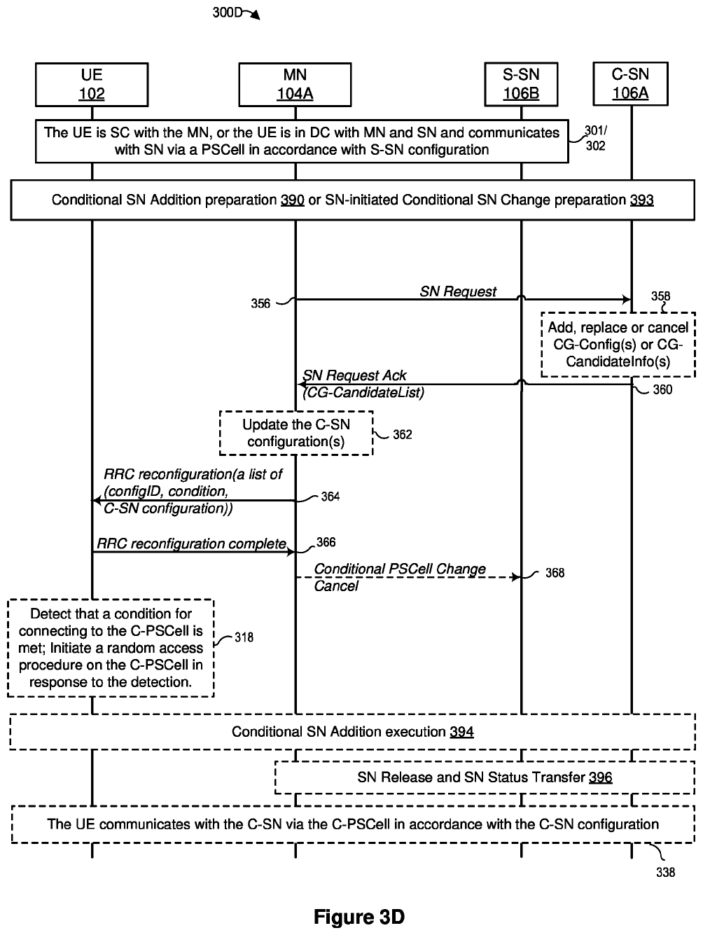

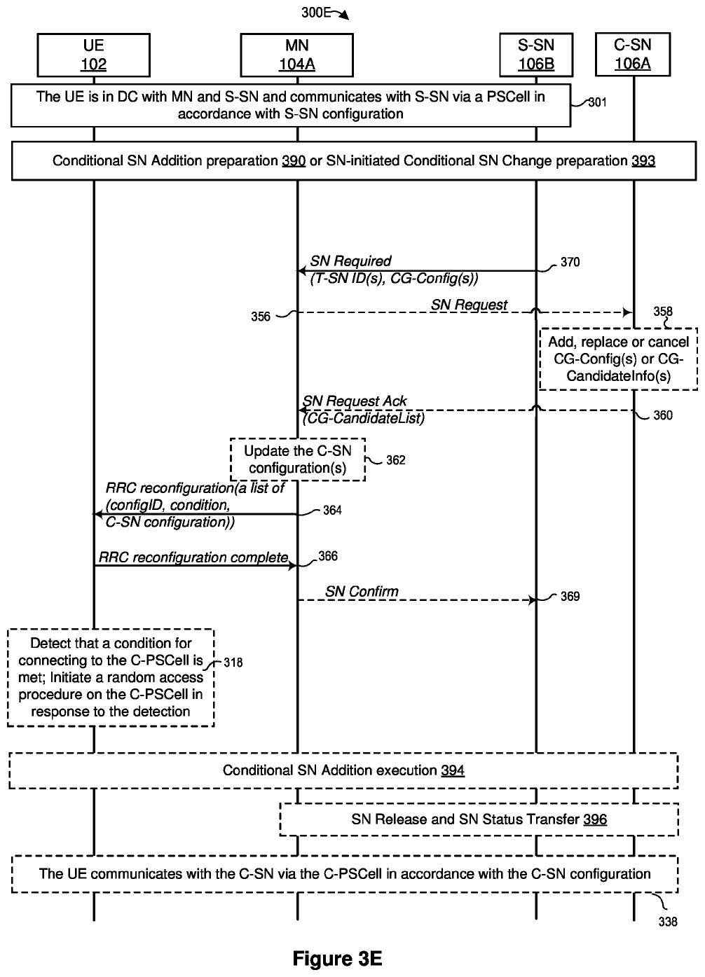

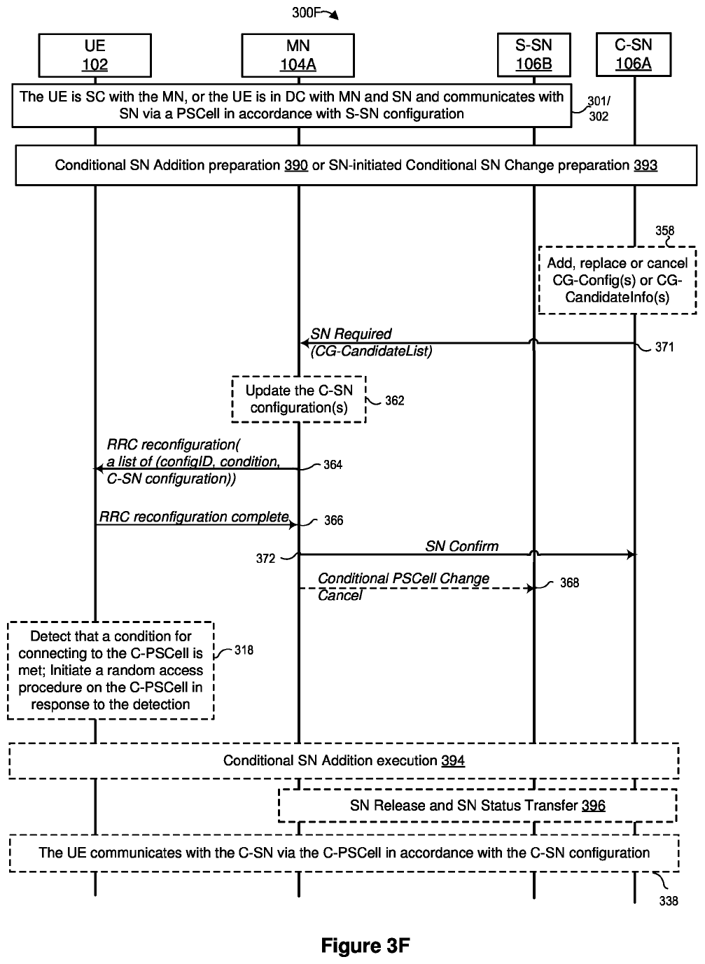

Next, several example scenarios in which a UE and/or a RAN perform the techniques of this disclosure for supporting conditional procedures are discussed with reference to FIGS. 3A-3F. Generally speaking, similar events in FIGS. 3A-3F are labeled with the same reference numbers, with differences discussed below where appropriate.

Referring first to FIG. 3A, in a scenario 300A, an MN receives and processes one or more SN configurations from the SN during a conditional SN addition procedure. In the scenario 300A, the base station 104A operates as an MN, and the base station 106A operates as a C-SN. Initially, the UE 102 operates 302 in single connectivity (SC) with the MN 104A. While in SC, the UE 102 communicates UL PDUs and/or DL PDUs with the MN 104A (e.g., via a PCell 124A) in accordance with an MN configuration.

At a later time, the MN 104A determines to configure the base station 106A as a C-SN for conditional PSCell addition (CPA). The MN 104A can make this determination based on measurement result(s) from the UE 102, for example. In some implementations, the MN 104A can detect or estimate that the UE 102 is moving toward an area of coverage (i.e., one or more cells) of the base station 106A based on uplink signals received from the UE 102 or positioning measurement result(s) received from the UE 102. In response to the determination, the MN 104A sends 304 an SNAddition Request message including a Conditional PSCell Addition Information Request IE to the C-SN 106A. In some implementations, the Conditional PSCell Addition Information Request IE further includes a CPAC indicator to indicate CPAC-initiation and a Maximum Number of PSCells To Prepare IE/field. The MN 104A can generate a candidate cell information (e.g, CandidateCellInfoListMN) including the measurement result(s) of the one or more cells and include the candidate cell information in the SNAddition Request message. Furthermore, the MN 104A can determine SN restriction information to restrict (values of) configuration parameters that the C-SN 106A can configure for the UE 102. The MN 104A can include the SN restriction information in the SNAddition Request message. The candidate cell information and/or the SN restriction information can be included in an inter-node RRC message CG-ConfigInfo. The MN 104A can also include the SN restriction information (e.g., Maximum Number of PSCells To Prepare) outside of the CG-ConfigInfo in the SN Addition Request message. The MN 104A may determine MN restriction information to restrict (values of) configuration parameters that the MN 104A can configure for the UE 102 when determining the SN restriction information.

In response to receiving 304 the SNAddition Request message with CPAC indication, the C-SN 106A determines 306 one or more C-PSCells (C-PSCell(s)) and generates an inter-node RRC message CG-CandidateList to include one or more C-SN configurations (C-SN configuration(s)), each C-SN configuration associated with a particular C-PSCell of the C-PSCell(s), for the UE 102. For example, the C-PSCells may be the cell 126A and the cell 126C. In some implementations, the C-SN 106A determines the C-PSCell(s) and the C-SN configuration(s) taking into account the candidate cell information and the SN restriction information. The CG-CandidateList includes an addition list (e.g., cg-CandidateToAddModList) of CG-CandidateInfo IE(s), where each corresponds to a C-PSCell. Each CG-CandidateInfo IE in the addition list includes C-PSCell information for a C-PSCell (e.g., SSB frequency information (e.g., ARFCN-ValueNR) and the physical Cell ID (PCI) or Cell Global ID (CGI)) and a CG-Config IE. Each CG-Config IE includes a C-SN configuration for a corresponding C-PSCell and optional parameters for the MN to prepare conditional configuration(s). In some implementations, the CG-CandidateInfo IE includes a CG-CandidateInfo ID (e.g., eg-CandidateInfoId or CG-CandidateInfold), which identifies each CG-CandidateInfo IE or a CG-Config IE in each CG-CandidateInfo IE by including the C-PSCell information for a C-PSCell (e.g., SSB frequency information (e.g., ARFCN-ValueNR) and the physical Cell ID (PCI) or Cell Global ID (CGI)) as ID. The CG-CandidateInfo ID(s) can be used by the C-SN 106A and the MN 104A for management of CG-CandidateInfo IE(s) in the addition list.

The C-SN 106A transmits 308 an SNAddition Request Acknowledge message including the CG-CandidateList and/or a Conditional PSCell Addition Information Acknowledge IE including the list of accepted candidate cell (CGI) to the MN 104A. In further implementations, the C-SN 106A can generate coordination information and include the coordination information in the SNAddition Request Acknowledge message. In some implementations, the coordination information includes one or more coordination parameters. In some implementations, the C-SN 106A can include the one or more coordination parameters in the CG-Config(s) in the CG-CandidateList and/or the SNAddition Request Acknowledge message. For example, the coordination information can include coordination parameters such as one or more power coordination parameters (e.g., powerCoordination-FR1 and/or powerCoordination-FR2), or a discontinuous reception (DRX) configuration (e.g., DRX-Info or DRX-Info2). The coordination information can include coordination information for each of the C-PSCell(s). In some implementations, the C-SN 106A includes SN restriction information in the SNAddition Request Acknowledge message, which the MN 104A may use to determine the MN restriction information. The events 304, 306, 308 collectively define a conditional SN addition preparation procedure 392.

After receiving 308 the SNAddition Request Acknowledge message including the CG-CandidateList, the MN 104A can assign a particular configuration ID (e.g., condReconfigId or CondReconfigurationId) to each of the C-SN configuration(s) in the CG-Config IE(s). For example, in cases where the CG-Config IE(s) include the C-SN configurations 1, . . . , N (N is an integer larger than zero), the MN 104A can assign configuration ID 1, . . . , N for the C-SN configurations 1, . . . , N, respectively. In such cases, the MN 104A can include the configuration ID 1, . . . , Nin the RRC reconfiguration message. In such implementations, the MN 104A can include, in the RRC reconfiguration, trigger condition configurations 1, . . . , N for the C-SN configurations 1, . . . , N, respectively. The MN 104A can generate the trigger condition configurations (e.g., condExecutionCond). Each of the trigger condition configurations can configure one or more conditions that triggers the UE 102 to connect to the C-SN 106A via a particular C-PSCell configured in a particular C-SN configuration. In some implementations, the MN 104A can generate conditional (re)configuration fields/IEs (e.g., CondReconfigToAddMod) 1, . . . , N, including the C-SN configurations (e.g., condRRCReconfig) 1, . . . , N, the configuration ID (e.g., condReconfigld) 1, . . . , N, and the trigger condition configurations (e.g., condExecutionCond) 1, . . . , N, respectively, and transmit 312 the RRC reconfiguration message including the conditional (re)configuration fields/IEs to the UE 102. In other implementations, the MN 104A can generate RRC container messages (e.g., RRCConnectionReconfiguration messages or RRCReconfiguration messages) 1, . . . , N including the C-SN configurations (e.g., condRRCReconfig) 1, . . . , N, respectively, generate conditional (re)configuration fields/IEs (e.g., CondReconfigToAddMod) 1, . . . , N including the RRC container messages 1, . . . , N, the configuration ID (e.g., condReconfigld) 1, . . . , N, and the condition configurations (e.g., condExecutionCond) 1, . . . , N, respectively, and transmit 312 the RRC reconfiguration message including the conditional configuration fields/IEs to the UE 102.

The MN 104A may include the C-SN configuration(s) in an RRC reconfiguration message (e.g., RRCConnectionReconfiguration message or RRCReconfiguration message), and transmit 312 the RRC reconfiguration message to the UE 102. In response, the UE 102 transmits 314 an RRC reconfiguration complete message (e.g., RRCConnectionReconfigurationComplete message or RRCReconfigurationComplete message) to the MN 104A. The events 312 and 314 collectively define an RRC reconfiguration procedure 310.

In some implementations, the MN 104A transmits an SN message (e.g., SN Reconfiguration Complete message, not shown) to the C-SN 106A to indicate that the UE 102 received the C-SN configuration(s), in response to or after receiving the RRC reconfiguration complete message. In other implementations, the MN 104A refrains from sending an SN message to the C-SN 106A to indicate that the UE 102 received the C-SN configuration(s). Events 304, 306, 308, 312 and 314 collectively define an MN-initiated conditional SN change (addition) preparation procedure 390, which includes the RRC reconfiguration steps not covered in procedure 392.

After receiving 314 the RRC reconfiguration complete message or an acknowledgement (e.g., RLC acknowledgement or hybrid automatic repeat request (HARQ) acknowledgement) for a PDU (e.g., RLC PDU or MAC PDU) including the RRC reconfiguration message, the MN 104A can (determine to) send 316 an Early Status Transfer message to the C-SN 106A to transfer a COUNT value of the first downlink SDU that the MN 104A forwards to the C-SN 106A or a COUNT value for discarding of already forwarded downlink SDUs for each of DRB(s) of the UE 102. The Early Status Transfer message may be an Early Sequence Number (SN) Status Transfer message, where “SN” in this context refers to sequence number rather than secondary node. The MN 104A can send 316 the Early Status Transfer message without receiving an interface message indicating the UE 102 connects to the C-SN 106A.

The UE 102 may use the one or more conditions to determine whether to connect to the one of the C-PSCell(s). If the UE 102 detects 318 that a condition for connecting to a C-PSCell is satisfied, the UE 102 connects to the C-PSCell. That is, the condition (or “triggering condition”) triggers the UE 102 to connect to the C-PSCell or to execute the C-SN configuration concerning the C-PSCell. However, if the UE 102 does not detect that the condition is satisfied, the UE 102 does not connect to the C-PSCell. In response to the detection, the UE 102 initiates a random access procedure on the C-PSCell. In response to the initiation, the UE 102 performs 320 the random access procedure with the C-SN 106A via the C-PSCell. In response to the detection or initiation 318, the UE 102 sends 322 an RRC reconfiguration complete message to the MN 104A. The UE 102 can send 322 the RRC reconfiguration complete message before, during or after the random access procedure.

In some implementations, the UE 102 may indicate, in the RRC reconfiguration complete message, that the UE 102 has executed one of the C-SN configuration(s) by including a configuration ID corresponding to the particular C-SN configuration. The MN 104A can use the configuration ID to identify or determine the ID of the C-PSCell (e.g., the PCI and/or the CGI of the C-PSCell 126A) and/or the C-SN if the MN 104A performs multiple CPA procedures with different C-SNs. The MN 104A can also use the configuration ID to identify or determine the C-SN configuration or the CG-Config TE including the C-SN configuration.

In response to or after receiving 322 the RRC reconfiguration complete message, the MN 104A can send 324 an SN message to the C-SN 106A. In some implementations, the SN message can be an SgNB Reconfiguration Complete or S-Node Reconfiguration Complete message. In other implementations, the SN message can be an RRC Transfer message. In yet other implementations, the SN message can be a new interface message (e.g., XnAP or X2AP message) defined in 3GPP 38.423 or 36.423 release 17 or future specifications. In some implementations, the UE 102 can include an SN RRC message (e.g., RRCReconfigurationComplete message) in the RRC reconfiguration complete message that the UE 102 transmits at event 322. In such cases, the MN 104A can include the SN RRC message in the SN message.

In some implementations, the random access procedure can be a four-step random access procedure or a two-step random access procedure. In other implementations, the random access procedure can be a contention-based random access procedure or a contention-free random access procedure. For example, the UE 102 may include an RRC reconfiguration complete message in a message 3 of the four-step random access procedure or in a message A of the two-step random access procedure.

After the C-SN 106A successfully completes the random access procedure with the UE 102, the C-SN 106A may transmit 326 an interface message (e.g., SNModification Required message, an NG-RAN node Configuration Update message, a E-UTRA—NR Cell Resource Coordination Request message, or a success indication message), which may include PSCell information of the PSCell (e.g., cell 126A) and/or the corresponding CG-Config IE and/or coordination information (e.g., SgNB Resource Coordination Information IE or MR-DC Resource Coordination Information IE) for Physical Resource Block (PRB) coordination to the MN 104A. The PSCell information can include a cell global identity (CGI), a physical cell identity (PCI), and/or an absolute radio frequency channel number (ARFCN) identifying a DL carrier frequency of the PSCell. In some implementations, the C-SN 106A can send 326 the interface message in response to or after receiving the SN message or performing 320 the random access procedure. In some implementations, the interface message further includes SN restriction information. The MN 104A may use the SN restriction information to determine the MN restriction information.

In response to, or after, receiving 322 the RRC reconfiguration complete message or 326 the interface message, the MN 104A applies 328 the coordination information and/or the MN restriction information. In response to applying 328 the coordination information and/or the MN restriction information, the MN 104A may transmit 330 an RRC reconfiguration message including configuration parameters to the UE 102. In some implementations, the configuration parameters 330 may reconfigure or release (values) of configuration parameters that the UE 102 uses to communicate with the MN 104A. In other implementations, the configuration parameters 330 may be new configuration parameters to configure the UE 102 to communicate with the MN 104A. In response to the RRC reconfiguration message 330, the UE 102 can transmit 332 an RRC reconfiguration message to the MN 104A. The MN 104A may in response transmit 334 an SN Modification Confirm message (e.g., SgNB Modification Confirm or S-Node Modification Confirm message). The events 320, 322, 324, 326, 328, 330, 332 and 334 are collectively referred to in FIG. 3A as a Conditional SN Addition execution procedure 394.

In response to, or after, receiving 322 the RRC reconfiguration complete message or 326 the interface message, the MN 104A can send 336 an SN Status Transfer message to transfer uplink PDCP SN and HFN receiver status and/or downlink PDCP SN and HFN transmitter status for each of DRB(s) of the UE 102. In contrast to event 316, the MN 104A sends 336 a (non-early) SN Status Transfer message.

After the UE 102 successfully completes the 320 the random access procedure, the UE 102 communicates 338 with the MN 104A and with the C-SN 106A via the C-PSCell in accordance with the C-SN configuration configuring the C-PSCell.

With continued reference to FIG. 3A, the C-SN configuration in some implementations is a complete and self-contained configuration (i.e., a full configuration). The C-SN configuration may include a full configuration indication (an information element (IE) or a field) that identifies the C-SN configuration as a full configuration. The UE 102 in this case uses the C-SN configuration to communicate with the SN 106A without relying on an SN configuration. On the other hand, the C-SN configuration in other cases includes a “delta” configuration, or one or more configurations that augment a previously received SN configuration. In these cases, the UE 102 uses the delta C-SN configuration together with the SN configuration to communicate with the C-SN 106A.

The C-SN configuration can include multiple configuration parameters for the UE 102 to apply when communicating with the SN 106A via a C-PSCell 126A. The multiple configuration parameters may configure the C-PSCell 126A and zero, one, or more candidate secondary cells (C-SCells) of the SN 106A to the UE 102. The multiple configuration parameters may configure radio resources for the UE 102 to communicate with the C-SN 106A via the C-PSCell 126A and zero, one, or more C-SCells of the C-SN 106A. The multiple configuration parameters may configure zero, one, or more radio bearers. The one or more radio bearers can include an SRB and/or one or more DRBs.

In some implementations, the C-SN configuration includes a group configuration (CellGroupConfig) IE that configures the C-PSCell 126A and zero, one, or more C-SCells of the C-SN 106A. In one implementation, the C-SN configuration includes a radio bearer configuration. In another implementation, the C-SN configuration does not include a radio bearer configuration. For example, the radio bearer configuration can be a RadioBearerConfig 1E, DRB-ToAddModList IE or SRB-ToAddModList IE, DRB-ToAddMod IE or SRB-ToAddMod IE. In various implementations, the C-SN configuration is an RRCReconfiguration message, RRCReconfiguration-IEs, or the CellGroupConfig IE conforming to 3GPP TS 38.331. The full configuration indication may be a field or an IE conforming to 3GPP TS 38.331. In other implementations, the C-SN configuration incudes an SCG-ConfigPartSCG-r12 IE that configures the C-PSCell 126A and zero, one, or more C-SCells of the C-SN 106A. In some implementations, the C-SN configuration is an RRCConnectionReconfiguration message, RRCConnectionReconfiguration-IEs, or the ConfigPartSCG-r12 IE conforming to 3GPP TS 36.331. The full configuration indication may be a field or an IE conforming to 3GPP TS 36.331.

Still referring to FIG. 3A, the base station 106A (i.e., the C-SN) in some cases includes the CU 172 and one or more DUs 174 as illustrated in FIG. 1C. For each of the C-SN configuration(s), the one or more DUs 174 can generate the C-SN configuration. Alternatively, for each of the C-SN configuration(s), the one or more DUs 174 can generate a portion of the C-SN configuration and the CU 172 may generate the remainder of the C-SN configuration. For example, the UE 102 performs 320 the random access procedure with the first DU 174A operating the (C-)PSCell 126A and the first DU 174A may identify the UE 102 in the random access procedure. In this case, the UE 102 communicates 338 with the SN 106A via the first DU 174A.

The first DU 174A of the C-SN 106A operating the C-PSCell 126A may generate the C-SN configuration configuring the C-PSCell 126A or a portion of the C-SN configuration and send the C-SN configuration or the portion of the C-SN configuration to the CU 172. In cases of a DU generating a portion of the C-SN configuration, the CU 172 generates the remainder of the C-SN configuration. In some scenarios or implementations, the first DU 174A generates each of the other C-SN configuration(s). Alternatively, for each of the other C-SN configuration(s), the first DU 174A generates a portion of the C-SN configuration and the CU 172 generates the remainder of the C-SN configuration. In other scenarios or implementations, the first DU 174A generates at least one first C-SN configuration in the C-SN configuration(s). Alternatively, for each of the at least one first C-SN configurations, the first DU 174A generates a portion of the C-SN configuration and the CU 172 generates the remainder of the C-SN configuration. A second DU 174B of the C-SN 106A generates at least one second C-SN configuration in the C-SN configuration(s). Alternatively, for each of the at least one second C-SN configurations, the second DU 174B generates a portion of the C-SN configuration and the CU 172 generates the remainder of the C-SN configuration.

Referring next to FIG. 3B, in an MN-initiated conditional SN Change scenario 300B, the MN 104A initially connects with a source SN (S-SN) 106B and later performs a conditional change procedure with the C-SN 106A. The interactions between MN 104A and C-SN 106A are similar to those described in FIG. 3A. The differences between FIG. 3B and FIG. 3A are described below.

The UE 102 is initially in dual connectivity 301 with MN 104A and S-SN 106B and communicates with S-SN 106B via a PSCell in accordance with an S-SN configuration. At a later time, the MN 104A, C-SN 106A, and UE 102 performs the Conditional SN Addition preparation_procedure 390. In cases where early data forwarding is needed, the MN 104A may transmit 340 an Interface message (e.g., Xn-U Address Indication or Data Address Indication message) to the S-SN 106B. The S-SN 106B then transmits 342 an Early Status Transfer message to the MN 104A and the MN 104A then transmits 316 an Early Status Transfer message to the C-SN 106A.

Similar to FIG. 3A, the UE 102 later detects 318 that a condition for connecting to the C-PSCell is met and performs a random access procedure on the C-PSCell in response to the detection with the C-SN 106A. The UE 102, MN 104A, and C-SN 106A perform the Conditional SN Addition execution 394. The MN 104A transmits 344 an SN Release Request message (e.g., SgNB Release Request or S-Node Release Request message) to the S-SN 106B. The S-SN 106B in response transmits 346 an SN Release Request Acknowledge message (e.g., SgNB Release Request Acknowledge or S-Node Release Request Acknowledge message). In cases where data forwarding is needed, the MN 104A may transmit 347 an Interface message (e.g., Xn-U Address Indication or Data Address Indication message) to the S-SN 106B. The S-SN 106B then may transmit 348 an SN Status Transfer message to the MN 104A and the MN 104A then may transmit 336 an SN Status Transfer message to the C-SN 106A. The MN 104A transmits 350 a UE Context Release message to the S-SN 106B. The events 344, 346, 347, 348, 336, 350 can be collectively referred as an SN Release and SN Status Transfer procedure 396.

After the UE 102 successfully completes the 320 the random access procedure, the UE 102 communicates 338 with the MN and with the SN via the C-PSCell 126A in accordance with the C-SN configuration configuring the C-PSCell 126A.

Referring next to FIG. 3C, in an SN-initiated conditional SN Change scenario 300C, the MN 104A initially connects with an S-SN 106B, and later the S-SN 106B later triggers the MN 104A to perform a conditional change procedure with the C-SN 106A and/or additional C-SN 104B not shown in the figure. The interactions between MN 104A and C-SN 106A (and/or C-SN 104B) are similar to those described in FIG. 3A or 3B. The differences between FIG. 3C and FIGS. 3A and 3B are described below.

The S-SN 106B at some time point decides to initiate a conditional SN change procedure for one or more C-SNs and transmits 303 an SN Change Required message (e.g., SgNB Change Required or S-Node Change Required message defined in the 3GPP TS 36.423 and 38.423, respectively) including one or more candidate Target SN ID(s) (e.g., Global en-gNB ID, or Global NG-RAN Node ID), and one or more CG-Config IE(s). The CG-Config TE includes 1) a candidate cell information (e.g., candidateCellInfoListSN defined in the 3GPP TS 38.331) which further contains the measurement result(s) received from the UE for immediate PSCell change or CPC operation and 2) a candidate cell information list for CPC (e.g., candidateCellInfoListCPC defined in the 3GPP TS 38.331) which further contains 1) the candidate cell(s) the C-SN(s) is allowed to choose from and 2) the trigger condition(s) (e.g., condExecutionCondSCG or condExecutionCondSN IE defined in the 3GPP TS 38.331, which may include measurement ID(s) referring to a configured S-SN measurement) for the corresponding candidate cell(s) to the MN 104A. The SN may also include respective SN restrictions (e.g., Maximum Number of PSCells To Prepare) for each C-SN. The MN 104A, according to the received Target SN ID(s), performs the Conditional SN Addition preparation procedure 392 with the C-SN 106A (and/or the C-SN 104B) with the proposed candidate cell information and the SN restrictions from the S-SN 106B. In the CG-ConfigInfo IE included in the SN Addition Request message, it includes 1) the candidateCellInfoListSN IE (instead of the candidateCellInfoListMN IE for FIGS. 3A and 3B) for the measurement results received from the S-SN and 2) the candidateCellListCPC IE for the proposed candidate cell list specifically for the C-SN 106A (and/or the C-SN 104B) from the S-SN 106B.

The following are example formats of several messages and information elements, which a base station can use to correlate the Target SN ID and the proposed candidate cell list from the S-SN, when preparing the CG-ConfigInfo IE for the corresponding C-SN.

According to the below format of the Conditional PSCell Change Information Required IE in the SN Change Required message, the S-SN includes the corresponding RRC Container which contains the proposed candidate cells only for the corresponding C-SN:

| IE/Group Name | Presence | Range | IE type and reference | Semantics description |
|---|---|---|---|---|
| Conditional PSCell Change | O | | | |
| Information Required | | | | |
| >Multiple Target S-NG-RAN Node | | 1 | | If this IE is present, the Target S- |
| List | | | | NG-RAN node ID IE and S-NG- |
| | | | | RAN node to M-NG-RAN node |
| | | | | Container shall be ignored. |
| >>Multiple Target S-NG-RAN Node | | 1 . . . | | |
| Item | | <maxnoofTargetSNs> | | |
| >>>Target S-NG-RAN node ID | M | | Global NG-RAN Node ID | |
| | | | 9.2.2.3 | |
| >>>CPAC Indicator | M | | ENUMERATED (CPAC- | |
| | | | initiation, CPC- | |
| | | | modification, CPC- | |
| | | | cancellation, . . . ) | |
| >>>RRC Container | M or O | OCTET | Includes the CG-Config | The CandidateCellInfoListCPC- |
| | | STRING | message as defined in | r17 in the CG-Config only |
| | | | subclause 11.2.2 of TS | contains the candidate cell |
| | | | 38.331 [10]. | belongs to the Target S-NG-RAN |
| | | | | node |
| >>>Maximum Number of PSCells | O | | INTEGER (1 . . . 8, . . . ) | Indicates the maximum number |
| To Prepare | | | | of PSCells that the target SN |
| | | | | may prepare. |
| >>>Estimated Arrival Probability | O | | INTEGER (1 . . . 100) | Indicates the arrival probability |
| | | | | for the UE towards the candidate |
| | | | | target SN. |

According to this format, the Target SN ID and RRC Container are in the same Multiple Target SN Node Item, and thus form a pair. The MN can use the CandidateCellInfoListCPC-r17 in the corresponding CG-Config to prepare the CandidateCellListCPC-r17 in the CG-ConfigInfo for the corresponding C-SN and include the CG-ConfigInfo in the SN Addition Request message.

Some of the relevant IEs are defined below:

CPCinformation-REQD :: = SEQUENCE {

| | |
|---|---|
| cpc-target-sn-list | CPC-target-SN-reqd-list, |
| iE-Extensions | ProtocolExtensionContainer { {CPCinformation-REQD- |

```
ExtIEs} } OPTIONAL,
  ...
}
CPCinformation-REQD-ExtIEs X2AP-PROTOCOL-EXTENSION ::= {
  ...
}
CPC-target-SN-reqd-list ::= SEQUENCE (SIZE(1..maxnoofTargetSNs)) OF CPC-
  target-SN-reqd-item
  CPC-target-SN-reqd-item ::= SEQUENCE {
```

| | |
|---|---|
| target-SgNB-ID | GlobalGNB-ID, |
| cpac-indicator | CPACindicator, |
| rrc-container | OCTET STRING, |
| max-no-of-pscells | INTEGER (1..maxnoofPSCellCandidates) |

OPTIONAL,

| | |
|---|---|
| estimatedArrivalProbability | CHO-Probability |

```
  OPTIONAL,
  iE-Extensions ProtocolExtensionContainer { {CPC-target-SN-reqd-item-
ExLIEs} } OPTIONAL,
  ...
}
CPC-target-SN-reqd-item-ExtIEs X2AP-PROTOCOL-EXTENSION :: = {
  ...
}
```

Thus, the S-NODE MODIFICATION REQUEST (with the direction of M-NG-RAN node→S-NG-RAN node) can have the following format:

| | | | IE type and | | | Assigned |
|---|---|---|---|---|---|---|
| IE/Group Name | Presence | Range | reference | Semantics description | Criticality | Criticality |
| . . . | . . . | . . . | . . . | . . . | . . . | . . . |
| >PDU Session Resources | | 0 . . . 1 | | | | |
| To Be Added List | | | | | | |
| >>PDU Session | | 1 . . . | | NOTE: If neither the | 1 | |
| Resources To Be Added | | <maxnoof | | PDU Session Resource | | |
| Item | | PDUSessions> | | Setup Info - SN | | |
| | | | | terminated IE | | |
| | | | | nor the | | |
| | | | | PDU Session Resource | | |
| | | | | Setup Info - MN | | |
| | | | | terminated IE | | |
| | | | | is present in a PDU | | |
| | | | | Session Resources To | | |
| | | | | Be Added Item IE, | | |
| | | | | abnormal conditions as | | |
| | | | | specified in clause | | |
| | | | | 8.3.3.4 apply. | | |
| . . . | . . . | . . . | . . . | . . . | . . . | . . . |
| >PDU Session Resources | | 0 . . . 1 | | | — | |
| To Be Modified List | | | | | | |
| >>PDU Session | | 1 . . . | | NOTE: If neither the | — | |
| Resources To Be Modified | | <maxnoof | | PDU Session Resource | | |
| Item | | PDUSessions> | | Modification Info - SN | | |
| | | | | terminated IE | | |
| | | | | nor the | | |
| | | | | PDU Session Resource | | |
| | | | | Modification Info - MN | | |
| | | | | terminated IE | | |
| | | | | is present in a PDU | | |
| | | | | Session Resources To | | |
| | | | | Be Modified Item IE, | | |
| | | | | abnormal conditions as | | |
| | | | | specified in clause | | |
| | | | | 8.3.3.4 apply. | | |
| . . . | . . . | . . . | . . . | . . . | . . . | . . . |
| CHO Information SN | O | | | | YES | reject |
| Modification | | | | | | |
| . . . | . . . | . . . | . . . | . . . | . . . | . . . |
| Conditional PSCell | O | | | | YES | ignore |
| Addition Information | | | | | | |
| Modification Request | | | | | | |
| >Maximum Number of | O | | INTEGER | Indicates the maximum | | |
| PSCells To Prepare | | | (1 . . . 8, . . .) | number of PSCells that | | |
| | | | | the target SN may | | |
| | | | | prepare. | | |
| >Estimated Arrival | O | | INTEGER | Indicates the arrival | — | |
| Probability | | | (1 . . . 100) | probability for the UE | | |
| | | | | towards the candidate | | |
| | | | | target SN. | | |
| Conditional PSCell Change | O | | | | YES | ignore |
| Information Update | | | | | | |
| >Candidate PSCell ID List | | 1 | | | — | |
| >>Candidate PSCell ID | | 1 . . . | | | — | |
| Item | | <maxnoof | | | | |
| | | PSCellCandidate> | | | | |
| >>>PSCell ID | M | | NR CGI | | — | |
| | | | 9.2.2.7 | | | |

The SN CHANGE REQUIRED can have the following format:

| | | | IE type and | | | Assigned |
|---|---|---|---|---|---|---|
| IE/Group Name | Presence | Range | reference | Semantics description | Criticality | Criticality |
| Message Type | M | | 9.2.3.1 | | YES | reject |
| M-NG-RAN node UE XnAP | M | | NG-RAN | Allocated at the M-NG- | YES | reject |
| ID | | | node UE | RAN node | | |
| | | | XnAP ID | | | |
| | | | 9.2.3.16 | | | |
| S-NG-RAN node UE XnAP | M | | NG-RAN | Allocated at the S-NG- | YES | reject |
| ID | | | node UE | RAN node | | |
| | | | XnAP ID | | | |
| | | | 9.2.3.16 | | | |
| Target S-NG-RAN node ID | M | | Global NG- | | YES | reject |
| | | | RAN Node | | | |
| | | | ID | | | |
| | | | 9.2.2.3 | | | |
| Cause | M | | 9.2.3.2 | | YES | ignore |
| PDU Session SN Change | | 0 . . . 1 | | | YES | ignore |
| Required List | | | | | | |
| >PDU Session SN Change | | 1 . . . | | NOTE: If the | — | — |
| Required Item | | <maxnoofPDUsessions> | | PDU Session Resource | | |
| | | | | Change Required Info - | | |
| | | | | SN terminated IE | | |
| | | | | is not present in a PDU | | |
| | | | | Session SN Change | | |
| | | | | Required Item IE, | | |
| | | | | abnormal conditions as | | |
| | | | | specified in clause | | |
| | | | | 8.3.5.4 apply. | | |
| >>PDU Session ID | M | | 9.2.3.18 | | — | |
| >>PDU Session Resource | O | | 9.2.1.18 | | — | |
| Change Required Info - | | | | | | |
| SN terminated | | | | | | |
| . . . | . . . | . . . | . . . | . . . | . . . | . . . |
| Conditional PSCell Change | O | | | | YES | ignore |
| Information Required | | | | | | |
| >Multiple Target S-NG- | | | | If this IE is present, the | — | — |
| RAN Node List | | | | Target S-NG-RAN node | | |
| | | | | ID IE and the S-NG-RAN | | |
| | | | | node to M-NG-RAN node | | |
| | | | | Container shall be | | |
| | | | | ignored. | | |
| >>Multiple Target S-NG- | | 1 . . . | | | - | |
| RAN Node Item | | <maxnoofTargetSNs> | | | | |
| >>>Target S-NG-RAN | M | | Global NG- | | — | |
| node ID | | | RAN Node | | | |
| | | | ID | | | |
| | | | 9.2.2.3 | | | |
| >>>Maximum Number of | O | | INTEGER | Indicates the maximum | — | |
| PSCells To Prepare | | | (1 . . . 8, . . . ) | number of PSCells that | | |
| | | | | the target SN may | | |
| | | | | prepare. | | |
| >>>Estimated Arrival | O | | INTEGER | Indicates the arrival | — | |
| Probability | | | (1 . . . 100) | probability for the UE | | |
| | | | | towards the candidate | | |
| | | | | target SN. | | |

According to another example implementation, the S-SN includes a CG-CandidateList in the SN to MN Container (e.g., S-NG-RAN node to M-NG-RAN node Container or SgNB to MeNB Container) in the SN Change Required message.

| | |
|---|---|
| CG-CandidateList-IEs ::= | SEQUENCE { |
| cg-CandidateToAddModList-r17 | SEQUENCE (SIZE (1..maxNrofConfCells- |
| r16)) OF CG-CandidateInfo-r17 | OPTIONAL, |
| cg-CandidateToReleaseList-r17 | SEQUENCE (SIZE (1..maxNrofConfCells- |
| r16)) OF CG-CandidateInfoId-r17 | OPTIONAL, |
| nonCriticalExtension | SEQUENCE { } |

OPTIONAL
}

| | |
|---|---|
| CG-CandidateInfo-r17 ::= | SEQUENCE { |
| cg-CandidateInfoId-r17 | CG-CandidateInfoId-r17, // the CG- |

CandidateInfold shall be ignored as it is for T-SN to MN
candidateCG-Config-r17
OCTET STRING (CONTAINING CG-Config)
//each pairs with a T-SN ID in Xn/X2 IE
}

According to this format, the sequence of the candidateCG-Config-r17 appearing in the CG-CandidateList is the same as the sequence of the Target SN ID appearing in the Conditional PSCell Change Information Required IE, so that the base station can pair this information. The MN can use the CandidateCellInfoListCPC-r17 in the corresponding CG-Config to prepare the CandidateCellListCPC-r17 in the CG-ConfigInfo for the corresponding C-SN and include the CG-ConfigInfo in the SN Addition Request message.

According to another example implementation, the S-SN includes a CG-Config with a full candidate cell list in the SN to MN Container (e.g., S-NG-RAN node to M-NG-RAN node Container or SgNB to MeNB Container) in the SN Change Required message.

| | |
|---|---|
| CG-Config-v17xy-IEs :: = | SEQUENCE { |
| candidateCellInfoListCPC-r17 | CandidateCellInfoListCPC-r17 |

OPTIONAL,

| | |
|---|---|
| nonCriticalExtension | SEQUENCE { } |

OPTIONAL
}
CandidateCellinfoListCPC-r17 ::= SEQUENCE (SIZE (1..FFS)) OF
CandidateCellinfo-r17

| | |
|---|---|
| CandidateCellinfo-r17 ::= | SEQUENCE { |
| ssbFrequency-r17 | ARFCN-ValueNR, |
| candidateList-r17 | SEQUENCE (SIZE (1..FFS)) OF |

CandidateCell-r17
}

| | |
|---|---|
| CandidateCell-r17 ::= | SEQUENCE { |
| physCellId-r17 | PhysCellId, |
| condExecutionCondSN-r17 | OCTET STRING (CONTAINING |
| CondReconfigExecCondSN-r17) | OPTIONAL |
| targetSNId-r17 | GlobalNG-RANNode-ID OPTIONAL |

}

Each of the CandidateCell-r17 elements has an additional target SN ID field/IE, so that the cell and SN ID can form a pair. The MN then divides the CandidateCellInfoListCPC-r17 according to the targetSNId to prepare the CandidateCellListCPC-r17 in the CG-ConfigInfo for the corresponding C-SN and include the CG-ConfigInfo in the SN Addition Request message.

According to yet another implementation, the S-SN includes a CG-CandidateList in the SN to MN Container (e.g., S-NG-RAN node to M-NG-RAN node Container or SgNB to MeNB Container) in the SN Change Required message.

| | |
|---|---|
| CG-CandidateList-IEs ::= | SEQUENCE { |
| cg-CandidateToAddModList-r17 | SEQUENCE (SIZE (1..maxNrofConfCells- |
| r16)) OF CG-CandidateInfo-r17 | OPTIONAL, |
| cg-CandidateToReleaseList-r17 | SEQUENCE (SIZE (1..maxNrofConfCells- |
| r16)) OF CG-CandidateInfoId-r17 | OPTIONAL, |
| nonCriticalExtension | SEQUENCE { } |

OPTIONAL
}

| | |
|---|---|
| CG-CandidateInfo-r17 ::= | SEQUENCE { |
| cg-CandidateInfoId-r17 | CG-CandidateInfoId-r17, // the CG- |

CandidateInfold shall be ignored as it is for T-SN to MN

| | |
|---|---|
| candidateCG-Config-r17 | OCTET STRING (CONTAINING CG-Config) |
| targetSNId-r17 | GlobalNG-RANNode-ID OPTIONAL |

}

Each of the CandidateInfo-r17 has an additional target SN ID field/IE, so that the candidateCG-Config and the targetSNId form a pair. The MN can use the CandidateCellInfoListCPC-r17 in the corresponding CG-Config to prepare the CandidateCellListCPC-r17 in the CG-ConfigInfo for the corresponding C-SN and include the CG-ConfigInfo in the SN Addition Request message.

According to another implementation, the S-SN includes a CG-Config with a full candidate cell list in the SN to MN Container (e.g., S-NG-RAN node to M-NG-RAN node Container or SgNB to MeNB Container) in the SN Change Required message. In the Conditional PSCell Change Information Required IE in the SN Change Required message, the S-SN may include the corresponding Candidate PSCell ID List with the proposed candidate cells only for the corresponding C-SN:

| IE/Group Name | Presence | Range | IE type and reference | Semantics description |
|---|---|---|---|---|
| Conditional PSCell Change | O | | | |
| Information Required | | | | |
| >Multiple Target S-NG-RAN Node | | 1 | | If this IE is present, the Target S- |
| List | | | | NG-RAN node ID IE shall be |
| | | | | ignored. |
| >>Multiple Target S-NG-RAN Node | | 1 . . . | | |
| Item | | <maxnoofTargetSNs> | | |
| >>>Target S-NG-RAN node ID | M | | Global NG-RAN Node ID | |
| | | | 9.2.2.3 | |
| >>>CPAC Indicator | M | | ENUMERATED (CPAC- | |
| | | | initiation, CPC- | |
| | | | modification, CPC- | |
| | | | cancellation, . . . ) | |
| >>>Candidate PSCell ID List | | 1 | | The corresponding candidate cell |
| | | | | list |
| >>>>Candidate PSCell ID Item | | 1 . . . | | |
| | | <maxnoofPSCellCandidate> | | |
| >>>>>PSCell ID | O | | NR CGI 9.2.2.7 | |
| >>>>>PSCell ID PCI | M | | NR PCI | |
| >>>Maximum Number of PSCells | O | | INTEGER (1 . . . 8, . . . ) | Indicates the maximum number |
| To Prepare | | | | of PSCells that the target SN |
| | | | | may prepare. |
| >>>Estimated Arrival Probability | O | | INTEGER (1 . . . 100) | Indicates the arrival probability |
| | | | | for the UE towards the candidate |
| | | | | target SN. |

According to the PSCell ID PCI in the Conditional PSCell Change Information Required IE, the MN can pair the Target SN and the candidate cell. The MN then divides the CandidateCellInfoListCPC-r17 according to Target SN ID to prepare the CandidateCellListCPC-r17 in the CG-ConfigInfo for the corresponding C-SN and include the CG-ConfigInfo in the SN Addition Request message.

According to another implementation, the S-SN includes a dedicated list (e.g., S-SN-CandidateList) in the SN to MN Container (e.g., S-NG-RAN node to M-NG-RAN node Container or SgNB to MeNB Container) in the SN Change Required message.

| | |
|---|---|
| S-SN-CandidateList-IEs ::= | SEQUENCE { |
| cg-CandidateList-r17 | SEQUENCE (SIZE (1..maxNrofConfCells-r16)) OF |

CG-CandidateInfo-r17 OPTIONAL,

| | |
|---|---|
| nonCriticalExtension | SEQUENCE { } |

OPTIONAL
}

| | |
|---|---|
| CG-CandidateInfo-r17 ::= | SEQUENCE { |
| candidateCG-Config-r17 | OCTET STRING (CONTAINING CG-Config) |

```
  //each pairs with a T-SN ID in Xn/X2 IE
  }
```

The sequence of the candidateCG-Config-r17 in the S-SN-CandidateList is in the same sequence of the Target SN ID in the Conditional PSCell Change Information Required IE, so that these units of formation form a pair. The MN can use the CandidateCellInfoListCPC-r17 in the corresponding CG-Config to prepare the CandidateCellListCPC-r17 in the CG-ConfigInfo for the corresponding C-SN and include the CG-ConfigInfo in the SN Addition Request message.

Another example implementation is illustrated in the table below:

Neighboring node 1

| | | |
|---|---|---|
| Served cell 1 | PCI 1 | CGI 1 |
| Served cell 2 | PCI 2 | CGI 2 |
| Served cell 3 | PCI 3 | CGI 3 |

Neighboring node 2

| | | |
|---|---|---|
| Served cell a | PCI a | CGI a |
| Served cell b | PCI b | CGI b |
| . . . | . . . | . . . |

The S-SN includes a CG-Config with a full candidate cell list with only cell PCI information in the SN to MN Container (e.g., S-NG-RAN node to M-NG-RAN node Container or SgNB to MeNB Container) in the SN Change Required message. In this example implementation, the MN shall first maintains a table of paired cell CGI and PCI (and/or ARFCN) for the neighboring nodes (e.g., via the Xn or X2 Setup procedure, the NG-RAN node Configuration Update procedure, the eNB Configuration Update procedure, or the CGI report from the UEs). According to the table and the received candidate cell ID (i.e., the CGI received in the Conditional PSCell Change Information Required IE or the PCI and ARFCN received in the CandidateCellInfoListCPC), the MN looks up the table and pairs the Target SN and the candidate cell. The MN then divides the CandidateCellInfoListCPC-r17 according to Target SN ID to prepare the CandidateCellListCPC-r17 in the CG-ConfigInfo for the corresponding C-SN and include the CG-ConfigInfo in the SN Addition Request message.

The MN 104A may transmit 352 an SN Request message (e.g., SgNB Modification Request or S-Node Modification Request message) to provide the candidate PSCell(s) accepted by the C-SN 106A (and/or the C-SN 104B) to the S-SN 106B. In some implementations, the SN Request message includes a Conditional PSCell Change Information Update IE which further includes the list of cell CGIs of the accepted candidate cells by the C-SN(s). The S-SN 106B in response may transmit 354 an SN Request Acknowledge message (e.g., SgNB Modification Request Acknowledge or S-Node Modification Request Acknowledge message) to provide the updated measurement configuration and/or trigger condition(s). In some implementations, the SN Request Acknowledge message may include a Conditional PSCell Change Information Update Response IE which further includes the updated measurement configuration and/or trigger condition(s) in one or more CG-Config IE(s). The one or more CG-Config IE(s) may each be included in a container in the Conditional PSCell Change Information Update Response IE. In other implementations, the SN Request Acknowledge message might not include a Conditional PSCell Change Information Update Response IE and the S-SN 106B includes a single CG-Config IE in the SN to MN Container to include the updated measurement configuration and/or trigger condition(s). The MN 104A performs 310 an RRC reconfiguration procedure with the UE 102 to configure the conditional configuration(s). The MN 104A transmits 309 an SN Change Confirm message (e.g., SgNB Change Confirm or S-Node Change Confirm message) to the S-SN 106B. The SN Change Confirm message may include the accepted candidate cells by the C-SN(s) if the MN does not send 352 the SN Request message. The SN Change Confirm message may include a RRC reconfiguration complete message for the S-SN 106B if the SN Request Acknowledge message at event 354 includes a RRC reconfiguration message. The events 303, 392, 352, 354, 310, and 309 can be collectively referred as the SN-initiated Conditional SN Change preparation procedure 393.

In some implementations, after the event 393, the S-SN 106B may further send an SN Modification Required message to trigger an update of CPC execution condition or corresponding SCG measurement configuration for CPC for the UE 102 if any. In this case, the MN 104A reconfigures the UE 102 as in the event 310. The MN 104A may send an SN Modification Confirm message to the S-SN 106B including an SN RRC reconfiguration complete message.

If the UE 102 later detects 318 that a condition for connecting to a C-PSCell is met, similarly the UE 102 performs the random access procedure with the C-SN 106A via the C-PSCell and the conditional SN addition execution procedure 394. The MN 104A, S-SN 106B, and C-SN 106A can perform 396 the SN Release and SN Status Transfer procedure.

Turning to FIGS. 3D-3F, scenarios 300D-300F are generally similar to the scenarios 300A-300C. However, the scenarios 300D-300F involve a modification (e.g., addition, replacement, or cancellation) to the prepared conditional SN addition or change configuration(s).

Referring first to FIG. 3D, in the scenario 300D the UE 102 initially either operates 302 in single connectivity (SC) with the MN 104A or operates 301 in DC with the MN 104A and S-SN 106B and communicates with the S-SN 106B via a PSCell in accordance with an S-SN configuration. The UE 102 later performs the Conditional SN Addition preparation procedure 390 for CPA per FIG. 3A or perhaps as part of an MN-initiated Conditional SN Change preparation procedure per FIG. 3B or the SN-initiated Conditional SN Change preparation procedure 393 with the MN 104A, (S-SN 106B) and the C-SN 106A for CPC per FIG. 3C.

At a later time, the MN 104A determines to change SN restriction (e.g., change the maximum number of PSCell to prepare) or update one or more measurement results (e.g., update the candidate cell information to include additional, different, or fewer candidate cell measurement result(s) when compared with the previous preparation in event 390 or 393). For example, a first candidate cell not under consideration during the procedure 390 or 393 may have a signal strength above a certain signal strength threshold, while a second candidate cell configured during the event 390 or 393 may have a signal strength below another certain signal strength threshold. The MN 104A transmits 356 an SN Request message (e.g., SgNB Modification Request or S-Node Modification Request message) including the updated SN restriction and/or measurement results. In some implementations, the updated SN restriction (e.g., the Maximum Number of PSCells To Prepare) is included in the Conditional PSCell Addition Information Modification Request IE in the SN Request message. The C-SN 106A, based on the updated information, performs 358 addition, replacement (i.e., modification), or cancellation (i.e., releasing) of CG-Config IE(s) or CG-CandidateInfo IE(s) associated with C-PSCell(s) for the UE 102. More specifically, the C-SN 106A can generate an addition list, a modification list, or a release list to add, modify, or release one or more CG-Config IE(s) or CG-CandidateInfo IE(s) associated with C-PSCell(s) for the UE 102, respectively. In response to receiving 356 the SN Request message, the C-SN 106A can send 360 an SN Request Acknowledge message (e.g., SgNB Modification Request Acknowledge or S-Node Modification Request Acknowledge message) including the addition list, modification list, and/or the release list to the MN 104A. In some implementations, the C-SN 106A can generate a CG-CandidateList including the addition list, modification list, and/or the release list and include the CG-CandidateList in the SN Request Acknowledge message. In other implementations, the C-SN 106A, for example, includes the release list as a separate IE from the CG-CandidateList in the SN Request Acknowledge message. In some implementations, the SN Request Acknowledge message includes a Conditional PSCell Addition Information Modification Acknowledge IE which further includes a full list of currently prepared PSCells.

The following paragraphs illustrate example implementations of the addition list, modification list, and release list, respectively, and how an MN 104A updates the CG-Config IE(s).

To add one or more CG-Config IE(s) or CG-CandidateInfo IE(s) associated with C-PSCell(s) for the UE 102, the C-SN 106A in one implementation generates the addition list including all the previous CG-CandidateInfo IE(s) sent to the MN 104A in event 390 or 393 and additionally the one(s) to be added, where each contains new C-PSCell information for a new C-PSCell (e.g., SSB frequency information (e.g., ARFCN-ValueNR) and the physical Cell ID (PCI) or Cell Global ID (CGI)) and a new CG-Config IE. After receiving 360 the addition list, the MN 104A replaces the previous CG-CandidateList of event 390 or 393 with the addition list. In an alternative implementation, the C-SN 106A includes, in the addition list, new CG-CandidateInfo IE(s) where each contains new C-PSCell information for a new C-PSCell and/or a new CG-Config IE and a new CG-CandidateInfo ID. In such cases, the C-SN 106A might or might not include, in the addition list, all the previous CG-CandidateInfo IE(s) sent to the MN 104A in event 390 or 393. Because of the new CG-CandidateInfo ID(s), the MN 104A retains the previous CG-CandidateInfo IE(s) of event 390 or 393 and stores (i.e., adds) the new CG-CandidateInfo IE(s).

To modify one or more of the previous CG-CandidateInfo IE(s) in the CG-CandidateList of event 390 or 393, each including C-PSCell information (e.g., SSB frequency information (e.g., ARFCN-ValueNR) and the physical Cell ID (PCI) or Cell Global ID (CGI)) for a configured C-PSCell, the C-SN 106A in one implementation generates the modification list including new CG-CandidateInfo IE(s), where each contains the C-PSCell information for the configured C-PSCell and a new CG-Config IE. The C-SN 106A can also include, in the modification list, other previous CG-CandidateInfo IE(s) in the CG-CandidateList of event 390 or 393 that the C-SN 106A determines not to modify. After receiving 360 the modification list, the MN 104A replaces all the previous CG-Config IE(s) or CG-CandidateInfo IE(s) in the CG-CandidateList of event 390 or 393 with the CG-Config IE(s) or CG-CandidateInfo IE(s) in the modification list. Alternatively, after receiving 360 the modification list, the MN 104A replaces the CG-CandidateList of event 390 or 393 with the modification list. In an alternative implementation, the C-SN 106A includes, in the modification list, new CG-CandidateInfo IE(s), where each contains C-PSCell information and/or a CG-Config IE, and an existing CG-CandidateInfo ID in the CG-CandidateInfo IE(s) of event 390 or 393. In accordance with the CG-CandidateInfo ID(s), the MN 104A identifies and modifies (or replaces) the CG-Config IE(s) and/or CG-CandidateInfo IE(s) of event 390 or 393. In such cases, the C-SN 106A might or might not include, in the modification list, the unmodified CG-CandidateInfo IE(s) that the C-SN 106A sent to the MN 104A in event 390 or 393.

In some implementations, the C-SN 106A can combine the addition list and modification list in a single list (e.g., CG-CandidateToAddModList). In such cases, the MN 104A, in accordance with the cell ID(s) and/or SSB frequency information and/or CG-CandidateInfo ID, identifies and adds (or modifies) the (existing) CG-Config IE(s) and/or CG-CandidateInfo IE(s) associated with the cell ID(s) and/or SSB frequency information, and/or CG-CandidateInfo ID. For example, if the cell ID(s) and/or SSB frequency information and/or CG-CandidateInfo ID does not exist after event 390 or 393, the MN 104A adds the CG-Config IE and/or CG-CandidateInfo IE; otherwise, the MN 104A modifies (or replaces) the existing CG-Config IE and/or CG-CandidateInfo IE.

To release one or more CG-Config IE(s) or CG-CandidateInfo IE(s) associated with C-PSCell(s) for the UE 102, the C-SN 106A in one implementation generates the release list including all the previous CG-Config IE(s) or CG-CandidateInfo IE(s) sent to the MN 104A except the one(s) to be released. After receiving 360 the updated CG-CandidateList, the MN 104A replaces the previous CG-CandidateList of event 390 or 393 with the release list. In an alternative implementation, the C-SN 106A includes, in the release list (e.g., cg-CandidateToReleaseList-r17), cell ID(s) information (e.g., PCI(s) or CGI(s)) of the C-PSCell(s) and/or the SSB frequency information associated with the C-PSCell(s) to indicate the CG-Config 1E(s) or CG-CandidateInfo IE(s) to be released. In accordance with the cell ID(s) and/or SSB frequency information, the MN 104A identifies and releases the CG-Config IE(s) and/or CG-CandidateInfo IE(s) associated with the cell ID(s) and/or SSB frequency information.

In some implementations, if the C-SN cancels or releases all previously prepared C-SN configuration(s), the 356 SN Request message can, instead of the SN Modification Request message, be a SgNB Release Request message or S-Node Release Request message excluding the updated information and the 360 SN Request Acknowledge message can be a SgNB Release Request Acknowledge message or S-Node Release Request Acknowledge message excluding the updated CG-CandidateList or the release list.

The MN 104A, after receiving 360 the SN Request Acknowledge message, may perform 362 updates to the (stored) C-SN configuration(s) according to the received information (e.g., the updated CG-CandidateList including the addition, modification, or release list or the separate release/modification list IEs) as described in the example implementations above for the addition, modification, or release list. In some implementations, to update the conditional configuration(s) at the UE 102, the MN 104A (does not identify and associate the CG-Config(s) and) treats the received information (e.g., the updated CG-CandidateList) as a fresh preparation of the conditional configuration(s) and proceeds as specified after event 308 in FIG. 3A for the following RRC reconfiguration procedure. In some implementations, the MN 104A, in accordance with the addition, modification, or release list, may associate the updated C-SN configuration(s) with the existing conditional configuration ID(s) (e.g., condReconfigId or CondReconfigurationId) or assign new conditional configuration ID(s) in case of adding new C-SN configuration(s). The updated C-SN configuration(s) are included in an RRC reconfiguration message. In some implementations, for CPAC replace or addition, the updated C-SN configuration(s) are included in a CondReconfigToAddModList, where each entry includes a configuration ID (e.g., condReconfigId or CondReconfigurationId), a triggering condition configuration (e.g., condExecutionCond), and a C-SN configuration (e.g., condRRCReconfig). For CPAC cancel, the updated C-SN configuration(s) are included in a CondReconfigToRemoveList, where each entry includes a configuration ID (e.g., condReconfigId or CondReconfigurationId). The MN 104A transmits 364 the RRC reconfiguration message including the updated C-SN configuration(s) to the UE 102. The UE 102 applies the reconfiguration(s) and transmits 366 an RRC reconfiguration complete message to the MN 104A.

In case of the SN-initiated conditional SN Change case (i.e., procedure 393 is performed), the MN 104A may transmit 368 a Conditional PSCell Change Cancel message to the S-SN 106B to inform the S-SN 106B that a list of prepared PSCells are cancelled in the C-SN 106A.

Similar to FIG. 3A or 3B, if there are still conditional configuration(s) configured at the UE 102 after event 364, the UE 102 may later detect that a condition is met for connecting to a C-PSCell and perform a random access procedure with the C-SN 106A via the C-PSCell. The conditional SN addition execution procedure 394 and/or the SN Release and SN Status Transfer procedure 396 are also performed.

Referring next to FIG. 3E, a scenario 300E is similar to the scenario 300D; however, in the scenario 300E, after the Conditional SN Addition preparation procedure 390 for MN-initiated CPC or SN-initiated Conditional SN Change preparation procedure 393, the S-SN 106B decides to initiate modification to the (prepared conditional) configuration(s). Further differences between FIG. 3D and FIG. 3E are described below.

In some implementations, the SN-initiated Conditional SN Change preparation procedure 393 is performed, and later the S-SN 106B, for example, updates one or more measurement results (e.g. update the candidate cell information to include additional, different, or fewer candidate cell(s) from the previous preparation in event 390 or 393) or changes SN restriction (e.g., Maximum Number of PSCells To Prepare) at the C-SN 106A. In other implementations, the MN-initiated Conditional SN Change preparation 390 is performed, and later the S-SN 106B, for example, decides to modify one or more configurations at the S-SN 106B. The S-SN 106B therefore transmits 370 an SN Required message (e.g., SgNB Modification Required, S-Node Modification Required, SgNB Change Required, or S-Node Change Required message) to the MN 104A, where the SN Required message may include the updated measurement results and/or the updated SN restriction (e.g., maximum number of PSCells can be prepared by each target SN) and/or the updated trigger condition(s) for the corresponding candidate cell(s) and the target SN ID and/or the updated S-SN configuration. For update/modification of previous CPC configuration provided in CPC preparation, the S-SN 106B might or might not include the RRC Container for the CG-Config in the SN Change Required message. (In cases where the S-SN configuration is to be updated, the MN 104A may perform an RRC reconfiguration procedure with the UE 102, not shown in FIG. 3E). The MN 104A transmits 356 an SN Request message (e.g., SgNB Modification Request or S-Node Modification Request message) including the updated measurement results and/or the updated SN restriction and/or the updated S-SN configuration to the C-SN 106A. The C-SN 106A, based on the updated information, performs 358 addition, replacement (i.e., modification), or cancellation (i.e., releasing) of CG-Config IE(s) or CG-CandidateInfo IE(s) associated with C-PSCell(s) for the UE 102. The C-SN 106A transmits 360 an SN Request Acknowledge message (e.g., SgNB Modification Request Acknowledge or S-Node Modification Request Acknowledge message) including an updated CG-CandidateList to the MN 104A, as described in FIG. 3D. After updating 362 the C-SN Configuration(s) as described in FIG. 3D and performing the RRC reconfiguration procedure 364 and 366 to update the C-SN configuration(s) at the UE 102, the MN 104A may transmit 374 an SN Confirm message (e.g., SgNB Modification Confirm, S-Node Modification Confirm, SgNB Change Confirm, S-Node Change Confirm message) to the S-SN 106B.

If the UE 102 later successfully detects that a condition for connecting to a C-PSCell is met and performs the Conditional SN Addition execution procedure 394, the MN 104A performs the SN Release and SN Status Transfer procedure 396 with the S-SN 106B and C-SN 106A. In cases where the SN-initiated Conditional SN Change preparation procedure 393 was performed, the MN 104A might not transmit 344 the SN Release Request message, and the S-SN 106B therefore might not transmit 346 the SN Release Request Acknowledge message in the SN Release and SN Status Transfer procedure 396.

Referring next to FIG. 3F, a scenario 300F is similar to scenario 300D or 300E; however, in the scenario 300F the C-SN 106A, after performing the Conditional SN Addition Preparation procedure 390 or the SN-initiated Conditional SN Change preparation procedure 393, may decide to modify one or more of the conditional configuration(s). In one example, the C-SN 106A determines to cancel one or more of the conditional configuration(s) in response to detecting congestion or a resource shortage. In another example, the C-SN 106A determines to modify one or more of the conditional configuration(s) in response to detecting a resource shortage. In yet another example, the C-SN 106A determines to configure new, additional conditional configuration(s) in response to detecting that more resources are available. The C-SN 106A performs 358 addition, replacement (i.e., modification), or cancellation (i.e., releasing) of CG-Config IE(s) or CG-CandidateInfo IE(s) associated with C-PSCell(s) for the UE 102. The C-SN 106A transmits 371 an SN Required message (e.g., SgNB Modification/Release Required or S-Node Modification/Release Required message), which may include the updated CG-CandidateList similar to the event 360. In some implementations, the SN Required message includes a Conditional PSCell Addition Information Required IE which further includes a full list of currently prepared PSCells. The MN 104A, similar to FIG. 3D or 3E, updates 362 the C-SN configuration(s) and performs 364 and 366 an RRC reconfiguration procedure with the UE 102 to reconfigure the C-SN configuration(s). The MN 104A transmits 372 an SN Confirm message (e.g., SgNB Modification/Release Confirm or S-Node Modification/Release Confirm message) to the C-SN 106A. In cases of SN-initiated conditional SN Change, the MN 104A may transmit 368 a Conditional PSCell Change Cancel message to the S-SN 106B to inform the S-SN 106B that a list of prepared PSCells are cancelled in the C-SN 106A. If the UE 102 detects that a condition for connecting to a C-PSCell is met, the UE 102 performs 394 the Conditional SN Addition execution procedure. The MN 104A, S-SN 106B, and C-SN 106A may then perform the SN Release and SN Status Transfer procedure 396.

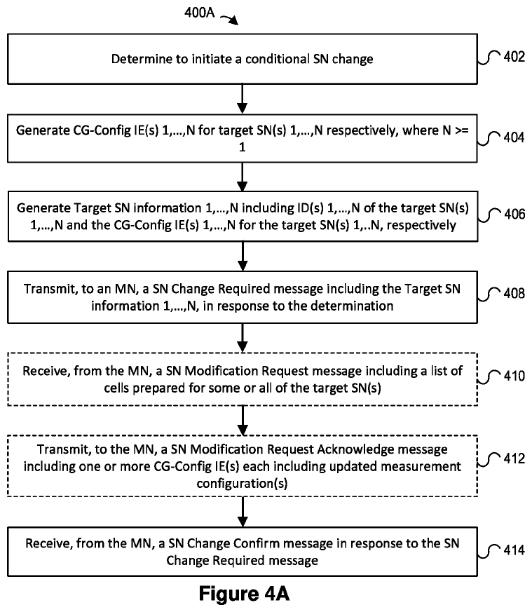

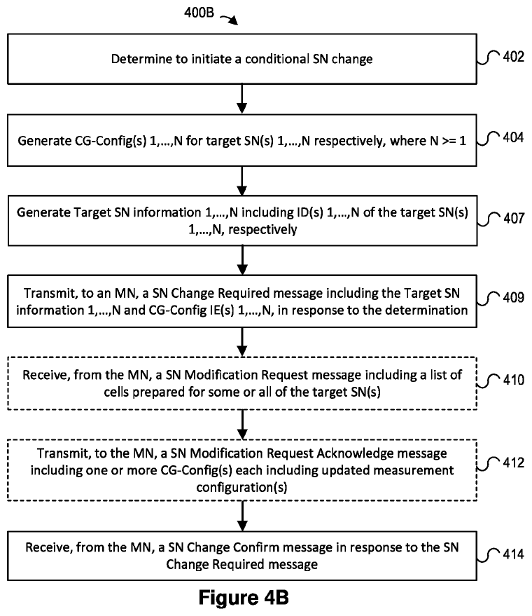

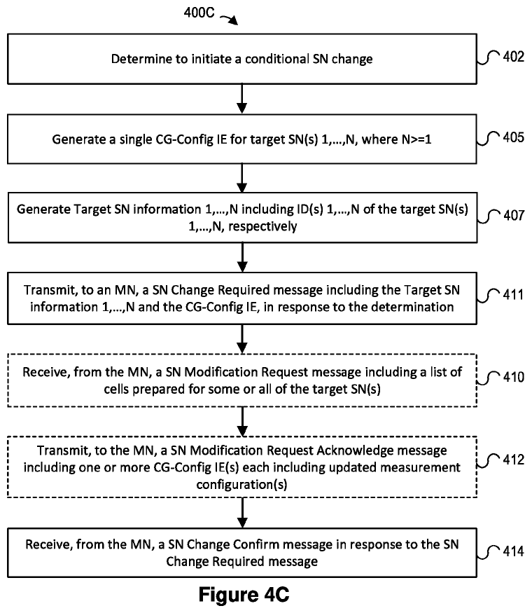

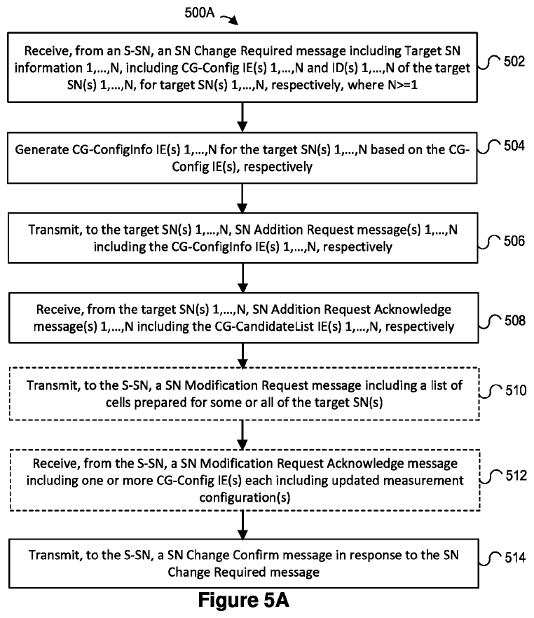

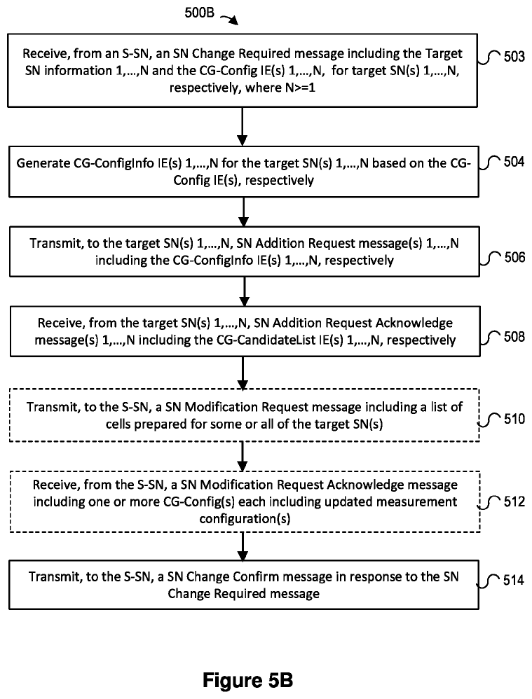

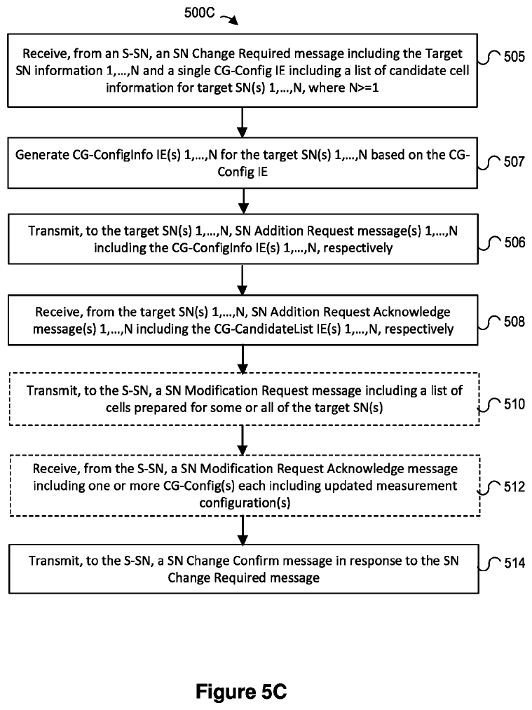

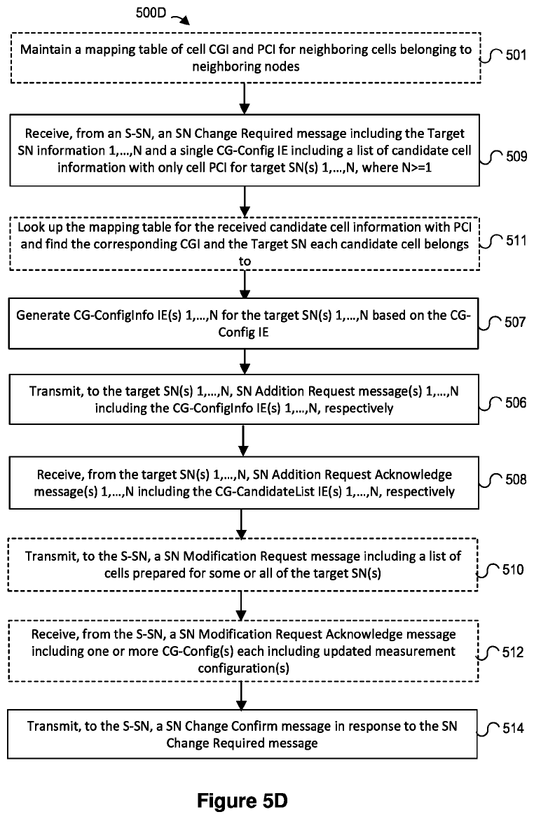

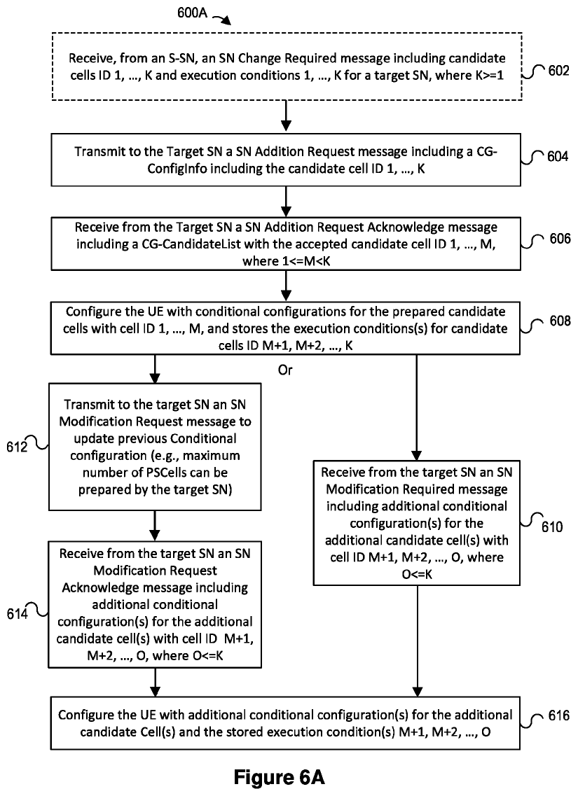

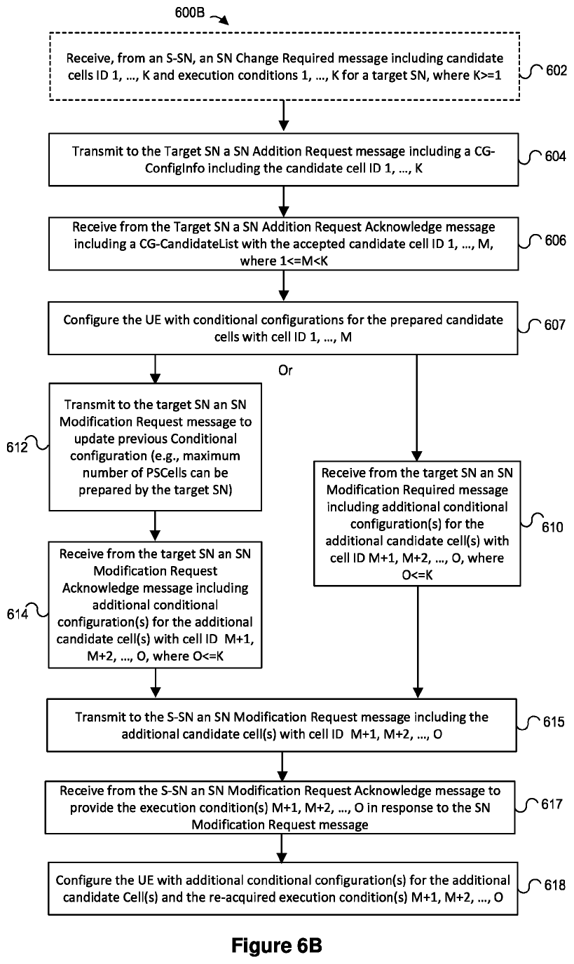

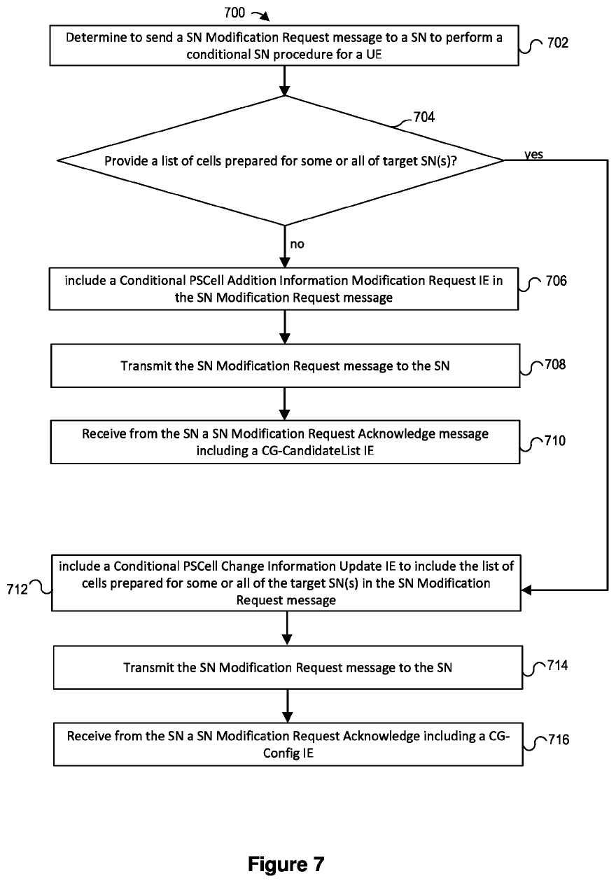

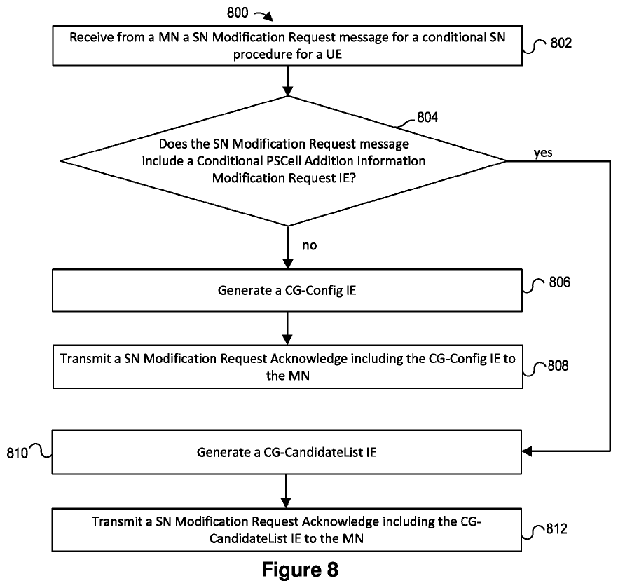

FIGS. 4-8 are flow diagrams of example methods that a base station (e.g., the base station 104A, 104B, 106A, or 106B) can implement to support conditional procedures in accordance with the techniques of this disclosure. The base stations that operate in the scenarios 300A-300F described above can implement some or all of these methods. FIGS. 4A-4C illustrate methods which an S-SN can implement to initiate a conditional SN change toward one or more C-SNs, respectively. FIGS. 5A-5D illustrate methods that an MN can implement to perform a conditional SN change toward one or more C-SNs in response to the requirement from the S-SN, respectively. FIGS. 6A-6B illustrate methods that an MN can implement to maintain or re-acquire the execution condition(s) from the S-SN for the C-SN configuration modification. FIG. 7 illustrates a method that an MN can implement to perform a SN modification to provide a list of cells prepared for some or all of the target SN(s) or request for modification during a CPAC procedure. FIG. 8 illustrates a method that an SN can implement to provide updated measurement configurations or execution conditions or perform modifications during a CPAC procedure.

Referring to FIG. 4A, an S-SN (e.g., the S-SN 106B) can implement a method 400A to initiate a conditional SN Change procedure with an MN (e.g., the MN 104A) toward one or more C-SNs (e.g., the C-SN 106A or 104B) for a UE (e.g., the UE 102) using one or more CG-Config(s).

In particular, at block 402, the S-SN determines to initiate a conditional SN change. At block 404, the S-SN generates CG-Config IE(s) 1, . . . , N for target SN(s) (i.e., C-SN(s)) 1, . . . , N, respectively, where N≥1. The S-SN at block 406 generates Target SN information (e.g., IE(s))) 1, . . . , N including ID(s) 1, . . . , N of the target SN(s) 1, . . . , N (i.e., T-SN ID(s) 1, . . . , N)) and the CG-Config IE(s) 1, . . . , N for the target SN(s) 1, . . . , N, respectively. At block 408, the S-SN transmits, to an MN, a SN Change Required message including the Target SN information 1, . . . , N, in response to the determination (e.g., event 303). At block 410, the S-SN may receive, from the MN, an SN Modification Request message including a list of cells prepared for some or all of the target SN(s) (e.g., event 352). At block 412, the S-SN, in response to 410, transmits, to the MN, an SN Modification Request Acknowledge message including one or more CG-Config IE(s) each including updated measurement configuration(s) (e.g., event 354). The S-SN at block 414 receives, from the MN, a SN Change Confirm message in response to the SN Change Required message (e.g., event 309).

In some implementations, the CG-Config IE(s) 1, . . . , N includes candidate cell information list 1, . . . , N for the target SN(s) 1, . . . , N. In some implementations, the candidate cell information list for a particular target SN includes 1) measurement result(s) of candidate cells (e.g., candidateCellInfoListSN) for immediate PCell change or CPC operation received from the UE and/or 2) a candidate cell information list for CPC (e.g., candidateCellInfoListCPC or candidateCellListCPC). The candidate cell information list for CPC includes a list of the candidate cell(s) that the C-SN can select as C-PSCell(s) for the UE. In some implementations, for each of the candidate cell(s), the S-SN can include trigger condition(s) (e.g., condExecutionCondSCG or condExecutionCondSN IE in the candidate cell information list.

In some implementations, the CG-Config IE for a particular target SN includes configuration parameters that the S-SN configures for the UE. The S-SN can transmit the configuration parameters to the UE directly (e.g., via SRB3) or via the MN, before initiating or determining to initiate the conditional SN change. The S-SN communicates with the UE in accordance with the configuration parameters. For example, the CG-Config IE can include an RRCReconfiguration message including the configuration parameters. In another example, the CG-Config IE includes a CellGroupConfig IE including the configuration parameters.

In some implementations, the S-SN can generate an container IE including the Target SN information 1, . . . , N and include the container IE in a new field or IE of the SN Change Required message.

In some implementations, the S-SN includes a SN to MN container IE in the SN Change Required message, because the SN to MN container IE is mandatory IE of the SN Change required message in accordance with 3GPP TS 36.423 and 38.423. In some implementations, the S-SN can generate the SN to MN container with a zero-bit length to prevent the MN from using the SN to MN container IE. In other implementations, the S-SN includes a CG-Config IE in the SN to MN container IE and the MN ignores or discards the CG-Config IE.

In some implementations, the MN includes the list of cells prepared for some or all of the target SN(s) in the SN Change Confirm message. In cases where the MN transmits the SN Modification Request message of block 410, the MN can refrain from including the list of cells prepared for some or all of the target SN(s) in the SN Change Confirm message. In such cases, the MN alternatively includes the list of cells prepared for some or all of the target SN(s) in the SN Change Confirm message

FIG. 4B is a flow diagram of an example method 400B, generally similar to the method 400A, except that the method 400B includes blocks 407 and 409 instead of blocks 406 and 408.

The S-SN at block 407 generates Target SN information (e.g., IE(s)) 1, . . . , N including ID(s) 1, . . . , N of the target SN(s) 1, . . . , N for the target SN(s) 1, . . . , N, respectively. At block 409, the S-SN transmits, to an MN, a SN Change Required message including the Target SN information 1, . . . , N, and CG-Config IE(s) 1, . . . , N, in response to the determination (e.g., event 303).

In some implementations, the Target SN information 1, . . . , N, and the CG-Config IE(s) 1, . . . , N, of the block 409 are included in the same sequence in the SN Change Required message so that MN can pair them based on the sequence (e.g., as in example implementation 2 of FIG. 3C). The CG-Config IE(s) 1, . . . , N, may be included in a container IE (e.g., as in example implementations 2 or 6 of FIG. 3C). In some implementations, the CG-Config IE(s) 1, . . . , N, are included in a container TE which further includes a companion T-SN ID 1, . . . , N, so that the MN can pair the Target SN information and the CG-Config(s) (e.g., as in example implementation 4 of FIG. 3C).

FIG. 4C is a flow diagram of an example method 400C, generally similar to the methods 400A and 400B, except that the method 400C includes blocks 405 and 411 instead of blocks 404 and 408.

At block 405, the S-SN generates a single CG-Config IE for target SN(s) (i.e., C-SN(s)) 1, . . . , N, respectively, where N≥1. In some implementations, the S-SN includes, in the CG-Config IE, candidate cell information list 1, . . . , N for the target SN(s) 1, . . . , N, respectively. The S-SN at block 407 generates Target SN information 1, . . . , N including ID(s) 1, . . . , N of the target SN(s) 1, . . . , N for the target SN(s) 1, . . . , N, respectively. At block 411, the S-SN transmits, to an MN, a SN Change Required message including the Target SN information 1, . . . , N, and the CG-Config IE, in response to the determination (e.g., event 303).

In some implementations, the candidate cell information in the CG-Config IE of the block 405 includes a companion T-SN ID so that MN can find the corresponding target SN for each candidate cell (e.g., as in example implementation 3 of FIG. 3C).

Turning to FIG. 5A, an MN (e.g., the MN 104A) can implement a method 500A to perform a conditional SN Change procedure initiated by an S-SN (e.g., the S-SN 106B) toward one or more C-SNs (e.g., the C-SN 106A or 104B) for a UE (e.g., the UE 102) using one or more CG-Config(s).

The method 500A starts at block 502 where the MN receives, from an S-SN, an SN Change Required message including the Target SN information (e.g., IE(s)) 1, . . . , N including CG-Config IE(s) 1, . . . , N and ID(s) 1, . . . , N of the target SN(s) 1, . . . , N, for target SN(s) 1, . . . , N, respectively, where N≥1. In some implementations, the CG-Config IE(s) 1, . . . , N includes candidate cell information list(s) 1, . . . , N for the target SN(s) 1, . . . , N, respectively (e.g., event 303). At block 504, the MN generates CG-ConfigInfo IE(s) 1, . . . , N for the target SN(s) 1, . . . , N based on the CG-Config IE(s), respectively. In some implementations, the MN includes candidate cell information list(s) 1, . . . , N in the CG-Config IE(s) 1, . . . , N, respectively. In some implementations, the MN retrieves information from the candidate cell information list received from the S-SN and include the retrieved information in the candidate cell information list generated by the MN. In some implementations, the retrieved information does not include trigger condition(s).

The MN at block 506 transmits, to the target SN(s) 1, . . . , N, SN Addition Request message(s) 1, . . . , N including CG-ConfigInfo IE(s) 1, . . . , N, respectively (e.g., event 304 or 392). In some implementations, the MN determines address(es) 1, . . . , N of the target SN(s) 1, . . . , N in accordance with the ID(s) 1, . . . , N and transmits the SN Addition Request message(s) 1, . . . , N to the address(es) 1, . . . , N of the target SN(s), respectively. In some implementations, the address(es) 1, . . . , N can be IP addresses 1, . . . , N, respectively. In such implementations, the MN can generate IP packet(s) 1, . . . , N, including the SN Addition Request messages(s) and the IP address(es) 1, . . . , N (i.e., as destination IP address(es) and an IP address of the MN (i.e., as a source IP address), respectively, and transmit the IP packet(s) on interface(s) with the target SN(s) 1, . . . , N.

At block 508, the MN receives, from the target SN(s) 1, . . . , N, SN Addition Request Acknowledge message(s) 1, . . . , N including the CG-CandidateList IE(s) 1, . . . , N, respectively. At block 510, the MN may transmit, to the S-SN, a SN Modification Request message including a list of cells prepared for some or all of the target SN(s) (e.g., event 352). The MN at block 512 may receive, from the S-SN, a SN Modification Request Acknowledge message including one or more CG-Config IE(s) each including updated measurement configuration(s) (e.g., event 354). At block 514, the MN transmits, to the S-SN, a SN Change Confirm message in response to the SN Change Required message (e.g., event 309).

Examples and implementations described for FIG. 4A can apply to FIG. 5A.

FIG. 5B is a flow diagram of an example method 500B generally similar to the method 500A, except that the method 500B includes block 503 instead of block 502.

The MN at block 503 receives, from an S-SN, an SN Change Required message including the Target SN information 1, . . . , N, and the CG-Config IE(s) 1, . . . , N, for target SN(s) 1, . . . , N, respectively, where N≥1 (e.g., event 303). The Target SN information 1, . . . , N, includes ID(s) 1, . . . , N of the target SN 1, . . . , N, respectively. To generate the CG-ConfigInfo IE(s) 1, . . . , N, in some implementation, the MN correlates the candidate cell information and the particular Target SN according to the sequence of the CG-Config IE(s) appearing in the container IE (e.g. as in example implementations 2 or 6 of FIG. 3C). In other implementations, the MN correlates the candidate cell information and the particular Target SN according to the Target SN ID included in the CG-Config IE(s) (e.g. as in example implementations 4 of FIG. 3C).

In some implementations, the S-SN can generate a container IE including the Target SN information 1, . . . , N and include the container IE in a new field or IE of the SN Change Required message.

In some implementations, the S-SN can include a SN to MN container IE in the SN Change Required message, because the SN to MN container IE is mandatory IE of the SN Change required message in accordance with 3GPP TS 36.423 and 38.423. In some implementations, the S-SN can generate the SN to MN container with a zero-bit length to prevent the MN from using the SN to MN container IE. In other implementations, the S-SN can include a CG-Config in the SN to MN container IE and the MN ignores or discards the CG-Config IE.

In some implementations, the MN can include the list of cells prepared for some or all of the target SN(s) in the SN Change Confirm message. In cases where the MN transmits the SN Modification Request message of block 410, the MN can refrain from including the list of cells prepared for some or all of the target SN(s) in the SN Change Confirm message. In such cases, the MN laternatively includes the list of cells prepared for some or all of the target SN(s) in the SN Change Confirm message.

FIG. 5C is a flow diagram of an example method 500C generally similar to the methods 500A and 500B, except that the method 500C includes blocks 505 and 507 instead of blocks 502/503 and 504.

At block 505, the MN receives, from an S-SN, an SN Change Required message including the Target SN information 1, . . . , N, and a single CG-Config IE including a list of candidate cell information for target SN(s) 1, . . . , N, where N≥1 (e.g., event 303). In some implementations, the Target SN information 1, . . . , N, includes ID(s) 1, . . . , N of the target SN(s) 1, . . . , N, respectively and the CG-Config IE includes the Target SN ID information (e.g., T-SN ID or CGI) along with the candidate cell (e.g. as in example implementation 3 of FIG. 3C). In other implementations, the Target SN information 1, . . . , N, includes ID(s) 1, . . . , N and lists of candidate cell PCI information of the target SN 1, . . . , N, respectively (e.g. as in example implementation 5 of FIG. 3C). With the information obtained at block 505, the MN can correlate the candidate cell information and the particular target SN. The MN correlates the candidate cell information and the particular target SN according to the Target SN ID information included in the CG-Config or cell PCI information included in the Target SN information 1, . . . , N. The MN generates CG-ConfigInfo(s) 1, . . . , N for Target SN(s) 1, . . . , N respectively, where each of the CG-ConfigInfo(s) 1, . . . , N includes a list of corresponding candidate cell information from the CG-Config for a particular Target SN. At block 507, the MN generates CG-ConfigInfo IE(s) 1, . . . , N with the corresponding candidate cell information for the target SN(s) 1, . . . , N based on the CG-Config IE.

In some implementations, the S-SN can generate an container IE including the Target SN information 1, . . . , N and include the container IE in a new field or IE of the SN Change Required message.

In some implementations, the S-SN can include a SN to MN container IE in the SN Change Required message, because the SN to MN container IE is mandatory IE of the SN Change required message in accordance with 3GPP TS 36.423 and 38.423. In some implementations, the S-SN can generate the SN to MN container with a zero-bit length to prevent the MN from using the SN to MN container IE. In other implementations, the S-SN can include a CG-Config in the SN to MN container IE and the MN ignores or discards the CG-Config IE.

In some implementations, the MN can include the list of cells prepared for some or all of the target SN(s) in the SN Change Confirm message. In cases where the MN transmits the SN Modification Request message of block 410, the MN can refrain from including the list of cells prepared for some or all of the target SN(s) in the SN Change Confirm message. In such cases, the MN alternatively includes the list of cells prepared for some or all of the target SN(s) in the SN Change Confirm message.

FIG. 5D is a flow diagram of an example method 500D generally similar to methods 500A-500C, except that the method 500D includes additional blocks 501 and 511 and blocks 509 and 507 instead of blocks 502/503/505 and 504. Different from methods 500A-500C, in the method 500D the MN does not rely on the information provided in the SN Change Required message to figure out the corresponding candidate cell(s) and the target SN.

The MN at block 501 may maintain a relationship of served cell PCI, CGI and/or neighboring RAN node ID (e.g., a data structure or a mapping table of cell CGI and PCI for neighboring cells belonging to neighboring nodes as in example implementation 7 of FIG. 3C). In some implementations, for the block 501, the MN maintains the relationship of paired cell CGI and PCI for the neighboring nodes via, for example, the Xn or X2 Setup procedure, the NG-RAN node Configuration Update procedure, the eNB Configuration Update procedure, or the CGI report from the UEs. The MN at block 509 receives, from an S-SN, an SN Change Required message including the Target SN information 1, . . . , N, with ID(s) 1, . . . , N of the target SN(s) 1, . . . , N, respectively and a single CG-Config IE including a list of candidate cell information with only cell PCI for target SN(s) 1, . . . , N, where N≥1 (e.g., event 303). At block 511, with the maintained relationship, the MN, for example, looks up the mapping table for the received candidate cell information with PCI and find the corresponding CGI and the target SN each candidate cell belongs to (e.g. as in example implementations 7 of FIG. 3C). The MN at block 507 generates CG-ConfigInfo(s) 1, . . . , N for target SN(s) 1, . . . , N respectively, where each of the CG-ConfigInfo(s) 1, . . . , N includes a list of corresponding candidate cell information from the CG-Config IE for a particular target SN.

In other implementations, the MN generates CG-ConfigInfo(s) 1, . . . , N for target SN(s) 1, . . . , N respectively, where each of the CG-ConfigInfo(s) 1, . . . , N includes the same full list of candidate cell information from the CG-Config IE for all target SNs. Each of the target SN(s) in such case finds out the candidate cell(s) operated by the target SN from the list.

Referring next to FIG. 6A, an MN (e.g., the MN 104A) can implement a method 600A to perform a conditional SN Change procedure initiated by an S-SN (e.g., the S-SN 106B) toward one or more C-SNs (e.g., the C-SN 106A or 104B) for a UE (e.g., the UE 102) and maintains the execution condition(s) for C-SN configuration modification.

The method 600A starts at block 602, where the MN receives, from an S-SN, an SN Change Required message including candidate cell ID(s) 1, . . . , K and execution conditions 1, . . . , K for a target SN, where K≥1(e.g., event 303). In some implementations, the SN Change Required message includes similar information for one or more target SNs as described for the methods 400A-C and 500A-500D. The MN at block 604 transmits to the target SN a SN Addition Request message including a CG-ConfigInfo including the candidate cell ID(s) 1, . . . , K (e.g., event 304). The MN at block 606 receives from the target SN a SN Addition Request Acknowledge message including a CG-CandidateList with the accepted candidate cell ID(s) 1, . . . , M, where 1≤M<K (e.g., event 308). The MN at block 608 configures the UE with conditional configuration(s) for the prepared candidate cell(s) with cell ID(s) 1, . . . , M, and stores the execution conditions(s) for candidate cell(s) ID M+1, M+2, . . . , K. The flow either proceeds to block 610 or block 612. The MN at block 610 receives from the target SN an SN Modification Required message including additional conditional configuration(s) for the additional candidate cell(s) with cell ID(s) M+1, M+2, . . . , O, where O≤K (e.g., event 371). At block 612, the MN transmits to the target SN an SN Modification Request message to update a previous conditional configuration (e.g., maximum number of PSCells can be prepared by the target SN) (e.g., event 356). At block 614, the MN receives from the target SN an SN Modification Request Acknowledge message including additional conditional configuration(s) for the additional candidate cell(s) with cell ID(s) M+1, M+2, . . . , O, where O≤K (e.g., event 360). At block 616, the MN configures the UE with additional conditional configuration(s) for the additional candidate cell(s) and the stored execution condition(s) M+1, M+2, . . . , O (e.g., event 364).

FIG. 6B is a flow diagram of an example method 600B generally similar to method 600A, except that the method 600B includes blocks 607, 615, 617, 618 instead of blocks 608 and 616.

The MN at block 607 configures the UE with conditional configurations for the prepared candidate cells (without storing the execution conditions(s) for candidate cells ID M+1, M+2, . . . , K. The MN at block 615 transmits to the S-SN an SN Modification Request message including the additional candidate cell(s) with cell ID M+1, M+2, . . . , O, where O≤K. The MN at block 617 receives from the S-SN an SN Modification Request Acknowledge message to provide the execution condition(s) M+1, M+2, . . . , O in response to the SN Modification Request message. The MN at block 618 configures the UE with additional conditional configuration(s) for the additional candidate Cell(s) and the re-acquired execution condition(s) M+1, M+2, . . . , O (e.g., event 364).

Referring next to FIG. 7, an MN (e.g., the MN 104A) can implement a method 700 to perform a conditional SN procedure for a UE (e.g., the UE 102) with an SN (e.g., the S-SN 106B or the C-SN 106A or 104B).

The method 700 starts at block 702, where the MN determines to send a SN Modification Request message to a SN to perform a conditional SN procedure for a UE (e.g., event 352 or 356). At block 704, the MN determines whether to include a list of cells prepared for some or all of target SN(s) in the SN Modification Request message. If the MN determines not to include a list of cells prepared for some or all of target SN(s), the flow proceeds to block 706 where the MN include a Conditional PSCell Addition Information Modification Request IE in the SN Modification Request message. The MN at block 708 transmits the SN Modification Request message to the SN (e.g., event 356). The MN at block 710 receives from the SN an SN Modification Request Acknowledge message including a CG-CandidateList IE.

If the MN determines to include a list of cells prepared for some or all of target SN(s), the flow proceeds to block 712 where the MN includes the list of cells prepared for some or all of the target SN(s) in a Conditional PSCell Change Information Update IE and include the Conditional PSCell Change Information Update IE in an SN Modification Request message. The MN at block 714 transmits the SN Modification Request message to the SN (e.g., event 352). The MN at block 716 receives from the SN an SN Modification Request Acknowledge including a CG-Config IE. In some implementations, the MN at block 716 receives an SN Modification Request Acknowledge including one or more CG-Config IE(s) in separate RRC Container(s).

Referring next to FIG. 8, an SN (e.g., the S-SN 106B or the C-SN 106A or 104B) can implement a method 800 to perform a conditional SN procedure for a UE (e.g., the UE 102) with an MN (e.g., the MN 104A).

The method 800 starts at block 802 where the SN receives from a MN a SN Modification Request message for a conditional SN procedure for a UE (e.g., event 352 or 356). The SN at block 804 determines whether the SN Modification Request message includes a Conditional PSCell Addition Information Modification Request IE. If the SN determines that the SN Modification Request message does not include a Conditional PSCell Addition Information Modification Request IE, the flow proceeds to block 806 where the SN generates CG-Config IE(s). Then at block 808 the SN transmits a SN Modification Request Acknowledge including the CG-Config IE(s) to the MN (e.g., event 354). If the SN determines that the SN Modification Request message includes a Conditional PSCell Addition Information Modification Request IE, the flow proceeds to block 810 where the SN generates a CG-CandidiateList IE. Then at block 812 transmits a SN Modification Request Acknowledge including the CG-CandidateList IE to the MN (e.g., event 360).

In some implementations, the SN Modification Request message includes a Conditional PSCell Addition Information Modification Request IE. In other implementations, the SN Modification Request message includes a Conditional PSCell Change Information Update IE.

In some implementations, the RAN node at block 806 generates one or more containers each including a particular CG-Config IE and includes the one or more containers in the SN Modification Request Acknowledge message at block 808. In some implementations, the RAN node at block 806 generates one single container to include a single CG-Config IE and includes the container in the SN Modification Request Acknowledge message at block 808.

In some implementations, the RAN node at block 810 includes the CG-Config IE(s) in the CG-CandidateList IE in the SN Modification Request Acknowledge message. In some implementations, the container can be a eg-CandidateList field, cg-CandidateList field-r17, CG-CandidateList-IEs IE, CG-CandidateList-r17 IE, cg-CandidateToAddModList field, cg-CandidateToAddModList field-r17, CG-CandidateToAddModList-r17 IE.

The following description may be applied to the description above.

Generally speaking, description for one of the above figures can apply to another of the above figures. An event or block described above can be optional or omitted. For example, an event or block with dashed lines in the figures can be optional. In some implementations, “message” is used and can be replaced by “information element (IE)”. In some implementations, “IE” is used and can be replaced by “field”. In some implementations, “configuration” can be replaced by “configurations” or the configuration parameters. In some implementations, the “CG-CandidateInfo ID” can be replaced by a “CG-Config ID” or another IE name.

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code, or machine-readable instructions stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC), a digital signal processor (DSP), etc.) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

What is claimed is:

1. A method in a master mode (MN) that provides, with a source secondary node (S-SN), a dual connectivity (DC) connection to a user equipment (UE), the method comprising:
receiving, from the S-SN, a first message indicating that a change in the SN is required for the UE, the message including a plurality of information elements (IEs) for a plurality of target SNs, to one of which the UE connects after a respective condition is satisfied, each of the IEs including (i) an identifier of a respective one of the plurality of target SNs and (ii) respective candidate cell information; and
transmitting, to the S-SN, a second message indicating that the change in the SN is confirmed.

2. The method of claim 1, further comprising:
in response to determining that the first message includes the IEs for the plurality of target SNs:
ignoring a target S-NG-RAN node identifier information IE included in the first message.

3. The method of claim 1 or 2, further comprising:
in response to determining that the first message includes the IEs for the plurality of target SNs:
ignoring an S-NG-RAN node to M-NG-RAN node container IE included in the first message.

4. The method of any of the preceding claims, wherein each of the plurality of IEs is a Target S-NG-RAN Node Item.

5. The method of claim 1, wherein the candidate cell information in each of the plurality of IEs is included in a respective CG-Config IE.

6. The method of claim 1, wherein the candidate cell information is included in an RRC Container.

7. The method of any of claims 5 or 6, wherein the candidate cell information includes trigger conditions for respective candidate cells.

8. The method of any of the preceding claims, wherein:
the first message is an S-Node Change Required message.

9. The method of any of the preceding claims, wherein:
the first message is an SgNB Change Required message.

10. A method in a source secondary node (S-SN) that provides, with a master node (MN), a dual connectivity (DC) connection to a user equipment (UE), the method comprising:
transmitting, to the MN, a first message indicating that a change in the SN is required for the UE, the message including a plurality of information elements (IEs) for a plurality of target SNs, to one of which the UE connects after a respective condition is satisfied, each of the IEs including (i) an identifier of a respective one of the plurality of target SNs and (ii) respective candidate cell information; and
receiving, from the MN, a second message indicating that the change in the SN is confirmed.

11. The method of any of the preceding claims, wherein each of the plurality of IEs is a Target S-NG-RAN Node Item.

12. The method of claim 11, wherein the candidate cell information in each of the plurality of IEs is included in a respective CG-Config IE.

13. The method of claim 12, wherein the candidate cell information is included in an RRC Container.

14. The method of any of claims 11-13, wherein the candidate cell information includes trigger conditions for respective candidate cells.

15. A node in a radio access network (RAN) comprising processing hardware and configured to implement a method according to any of the pending claims.
